(19) United States
(12) Patent Application Publication
(10) Pub. No.: US 2025/0238960 A1
(43) Pub. Date: Jul. 24, 2025

(54) Method and Apparatus for Lossless Encoding 3D Mesh

(71) Applicant: TENCENT AMERICA LLC, Palo Alto, CA (US)

(72) Inventors: Thuong NGUYEN CANH, Palo Alto, CA (US); Xiaozhong XU, Palo Alto, CA (US); Shan LIU, Palo Alto, CA (US)

(73) Assignee: TENCENT AMERICA LLC, Palo Alto, CA (US)

(21) Appl. No.: 19/033,255

(22) Filed: Jan. 21, 2025

Related U.S. Application Data
(60) Provisional application No. 63/623,752, filed on Jan. 22, 2024.

(51) Int. Cl. G06T 9/00; G06T 15/04; G06T 17/20; H04N 19/597

(52) U.S. Cl. CPC G06T 9/001; G06T 15/04; G06T 17/20; H04N 19/597

(57) ABSTRACT

This disclosure relates generally to encoding and decoding of 3-dimensional (3D) mesh and specifically to encoding and decoding order and dependency between 3D positions of 3D vertices and 2D positions of 2D texture coordinates of a 3D mesh. In particular, the various embodiments in this disclosure provide a novel method and device to enhance lossless compression of 3D mesh models. The disclosed method and device prioritize encoding texture coordinates before encoding 3D positions. The disclosed method and device further employ angle-preserving position prediction. The disclosed approaches aim to optimize the compression process of 3D meshes by leveraging an inherent correlation between 3D structures and their corresponding 2D texture mappings.

This application is based on and claims the benefit of priority to U.S. Provisional Patent Application No. 63/623,752 filed on Jan. 22, 2024, and entitled “METHOD AND APPARATUS FOR LOSSLESS ENCODING 3D MESH,” which is herein incorporated by reference in its entirety.

### TECHNICAL FIELD

This disclosure relates generally to encoding and decoding of 3-dimensional (3D) mesh and specifically to encoding and decoding order and dependency between 3D positions of 3D vertices and 2D positions of 2D texture coordinates of a 3D mesh.

### BACKGROUND

This background description provided herein is for the purpose of generally presenting the context of this disclosure. Work of the presently named inventors, to the extent the work is described in this background section, as well as aspects of the description that may not otherwise qualify as prior art at the time of filing of this application, are neither expressly nor impliedly admitted as prior art against the present disclosure.

Various technologies are developed to capture, represent, and simulate real world objects, environments and the like in 3D space. 3D representations of the world can enable more immersive forms of interactive communications. Example 3D representations of objects and environments includes but is not limited to point clouds and meshes. A series of 3D representation of objects and environments may form a video sequence. Redundancies and correlations within the sequence of 3D representations of objects and environments may be utilized for compressing and coding such a video sequence into a more compact digital form. As one example of such redundancies and correlations, reflection symmetry in a 3D mesh may be utilized to enhance compression efficiency.

### SUMMARY

This disclosure relates generally to encoding and decoding of 3-dimensional (3D) mesh and specifically to encoding and decoding order and dependency between 3D positions of 3D vertices and 2D positions of 2D texture coordinates of a 3D mesh. In particular, the various embodiments in this disclosure provide a novel method and device to enhance lossless compression of 3D mesh models. The disclosed method and device prioritize encoding texture coordinates before encoding 3D positions. The disclosed method and device further employ angle-preserving position prediction. The disclosed approaches aim to optimize the compression process of 3D meshes by leveraging an inherent correlation between 3D structures and their corresponding 2D texture mappings.

In some example implementations, a method for decoding a 3D mesh is disclosed. The method may include receiving a compressed bitstream of a portion of the 3D mesh; reconstructing 2D positions of a set of 2D texture coordinates associated with the portion of the 3D mesh from the compressed bitstream; and reconstructing, from the compressed bitstream and based on the 2D positions of the set of 2D texture coordinates as reconstructed, 3D positions of a set of 3D geometry vertices corresponding to the set of 2D texture coordinates.

In the example implementations above, the method may further include reconstructing, from the compressed bitstream, connectivity of the set of 3D geometry vertices and connectivity of the set of 2D texture coordinates prior to reconstructing the 2D positions of the set of 2D texture coordinates.

In any one of the example implementations above, the method may further include reconstructing from the compressed bitstream the 2D positions of the set of 2D texture coordinates along with connectivity of the set of 2D texture coordinates in tandem.

In any one of the example implementations above, reconstructing from the compressed bitstream the 3D positions of the set of 3D geometry vertices based on the 2D positions of the set of 2D texture coordinates as reconstructed is based on a shape-preserving prediction.

In any one of the example implementations above, reconstructing from the compressed bitstream the 3D positions of the set of 3D geometry vertices based on the 2D positions of the set of 2D texture coordinates as reconstructed comprises: obtaining reconstructed 3D positions of a first, a second, and a third 3D geometry vertices of the 3D mesh; obtaining reconstructed 2D positions of a first, a second, a third, and a fourth 2D texture coordinates corresponding to the first, the second, the third, and a fourth 3D geometry vertices, respectively; and deriving a 3D position of the fourth 3D geometry vertex based on the reconstructed 3D positions of the first, the second, and the third geometry vertices and the reconstructed 2D positions of the first, the second, the third, and the fourth 2D texture coordinates.

In any one of the example implementations above deriving the 3D position of the fourth 3D geometry vertex based on the reconstructed 3D positions of the first, the second, and the third geometry vertices and the reconstructed 2D positions of the first, the second, the third, and the fourth 2D texture coordinates comprises: determining weighting factors for generating a weighted sum of the reconstructed 2D positions of the first, the second, and the third 2D texture coordinates that optimally predicts the reconstructed 2D position of the fourth 2D texture coordinate; applying the weighting factors to the reconstructed 3D positions of the first, the second, and the third 3D geometry vertices to generate a weighted 3D position sum; and using the weighted 3D position sum as a predictor to obtain the 3D position of the fourth 3D geometry vertex.

In any one of the example implementations above, deriving the 3D position of the fourth 3D geometry vertex based on the reconstructed 3D positions of the first, the second, and the third geometry vertices and the reconstructed 2D positions of the first, the second, the third, and the fourth 2D texture coordinates comprises: deriving a 2D position predictor for the fourth 2D texture coordinate based on the reconstructed 2D positions of the first, the second, and the third 2D texture coordinates using a predefined geometric prediction mechanism; deriving a scaling factor that indicates a prediction accuracy of the 2D position predictor on the reconstructed 2D position of the fourth 2D texture coordinate; deriving an initial 3D position predictor for the fourth 3D geometry vertex based on the reconstructed 3D positions of the first, the second, and the third 3D geometry vertices using the predefined geometric prediction mechanism; applying the scaling factor to the initial 3D position predictor to generate a modified 3D position predictor; and using the modified 3D position predictor to obtain the 3D position of the fourth 3D geometry vertex.

In any one of the example implementations above, the predefined geometric prediction mechanism comprises a parallelogram prediction; and the scaling factor is derived as a ratio between the 2D position predictor and the reconstructed 2D position of the fourth 2D texture coordinate.

In any one of the example implementations above, the predefined geometric prediction mechanism comprises a parallelogram prediction; and the scaling factor is derived as a ratio between a first distance and a second distance, the first distance being between the 2D position predictor and a reconstructed position of an opposing 2D texture coordinate to the fourth 2D textual coordinate among the first, the second, and the third 2D texture coordinates, and the second distance being between the reconstructed 2D position of the fourth 2D textual coordinate and the reconstructed position of the opposing 2D texture coordinate.

In any one of the example implementations above, the predefined geometric prediction mechanism comprises an angle preserving prediction.

In some other example implementations, an electronic device for encoding a 3D mesh is disclosed. The electronic device includes a memory for storing instructions and at least one processor in communication with the memory and for executing the instructions to: receive 3D positions of a set of 3D geometry vertices and corresponding 2D positions of a set of 2D texture coordinates of the 3D mesh; process the 2D positions to generate encoded 2D positions for the set of 2D texture coordinates; generate encoded 3D positions based on the 3D positions and the encoded 2D positions; and include the encoded 2D positions and encoded 3D positions in a bitstream of the 3D mesh.

In the example implementations above, the at least one processor is configured to execute the instructions to: encode connectivity of the 3D geometry vertices and connectivity of the 2D texture coordinates prior to encoding the 2D positions of the set of 2D texture coordinates, wherein the encoded 2D position is further generated based on the encoded connectivity of the 3D geometry vertices or the encoded the connectivity of the 2D texture coordinates.

In any one of the example implementations above, the at least one processor is configured to execute the instructions to generate the encoded 2D positions of the 2D texture coordinates along with connectivity of the 2D texture coordinates in tandem.

In any one of the example implementations above, generating the encoded 3D positions based on the 3D positions and the encoded 2D positions is based on a shape-preserving prediction.

In any one of the example implementations above, the at least one processor is configured to generate the encoded 3D positions of the set of 3D geometry vertices by: determining reconstructed 3D positions of a first, a second, and a third geometry vertices of the 3D mesh; determining reconstructed 2D positions of a first, a second, a third, and a fourth 2D texture coordinates corresponding to the first, the second, the third, and a fourth 3D geometry vertices, respectively; and encoding a 3D position of the fourth 3D geometry vertex based on the reconstructed 3D positions of the first, the second, and the third geometry vertices and the reconstructed 2D positions of the first, the second, the third, and the fourth 2D texture coordinates.

In any one of the example implementations above, the at least one processor is configured to encode the 3D position of the fourth 3D geometry vertex by: determining weighting factors for generating a weighted sum of the reconstructed 2D positions of the first, the second, and the third 2D texture coordinates that optimally predicts the reconstructed 2D position of the fourth 2D texture coordinate; applying the weighting factors to the reconstructed 3D positions of the first, the second, and the third 3D geometry vertices to generate a weighted 3D position sum; and using the weighted 3D position sum as a predictor to encode the 3D position of the fourth 3D geometry vertex.

In any one of the example implementations above, the at least one processor is configured to encode the 3D position of the fourth 3D geometry vertex by: deriving a 2D position predictor for the fourth 2D texture coordinate based on the reconstructed 2D positions of the first, the second, and the third 2D texture coordinates using a predefined geometric prediction mechanism; deriving a scaling factor that indicates a prediction accuracy of the 2D position predictor on the reconstructed 2D position of the fourth 2D texture coordinate; deriving an initial 3D position predictor for the fourth 3D geometry vertex based on the reconstructed 3D positions of the first, the second, and the third 3D geometry vertices using the predefined geometric prediction mechanism; applying the scaling factor to the initial 3D position predictor to generate a modified 3D position predictor; and using the modified 3D position predictor to encode the 3D position of the fourth 3D geometry vertex.

In any one of the example implementations above, the predefined geometric prediction mechanism comprises a parallelogram prediction; and the scaling factor is derived as a ratio between the 2D position predictor and the reconstructed 2D position of the fourth 2D texture coordinate or as a ratio between a first distance and a second distance, the first distance being between the 2D position predictor and a reconstructed position of an opposing 2D texture coordinate to the fourth 2D textual coordinate among the first, the second, and the third 2D texture coordinates, and the second distance being between the reconstructed 2D position of the fourth 2D textual coordinate and the reconstructed position of the opposing 2D texture coordinate.

In some other example implementations, a method for encoding a 3D mesh is disclosed. The method may include receiving 3D positions of a set of 3D geometry vertices and 2D positions of a set of 2D texture coordinates of a 2D texture mapping of one or more portions of the 3D mesh, the set of 3D geometry vertices corresponding to the set of 2D texture coordinates; determining an encoding order and an encoding dependency of the 3D positions and the 2D positions based on a metrics for distance preservation between the 3D positions and the 2D texture mapping for each of the one or more portions of the 3D mesh; and encoding the each of the one or more portions of the 3D mesh according to the encoding order and the encoding dependency.

In the example implementations above, the method may further include selecting a prediction mechanism when encoding the each of the portions of the 3D mesh according to optimizing a prediction accuracy measure or encoding efficiency.

Aspects of the disclosure also provide an electronic device or apparatus function as encoder or decoder including a circuitry configured to carry out any of the method implementations above.

Aspects of the disclosure also provide non-transitory computer-readable medium for storing computer instructions which when executed by a computer for 3D mesh processing, cause the computer to perform any one of the method implementations above.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of a simplified block diagram of an example communication system in accordance with an embodiment of this disclosure;

FIG. 2 is a schematic illustration of a simplified block diagram of an example streaming system in accordance with an embodiment of this disclosure;

FIG. 3 shows a data flow in an encoding and decoding of 3D mesh or point cloud frames according to some embodiments of this disclosure;

FIG. 4 shows a block diagram of an encoder for encoding 3D mesh or point cloud frames, according to some embodiments of this disclosure;

FIG. 5 shows a block diagram of a decoder for decoding a compressed bitstream corresponding to 3D mesh and point cloud frames according to some embodiments of this disclosure;

FIG. 6 is a schematic illustration of a simplified block diagram of a video decoder in accordance with an embodiment of this disclosure;

FIG. 7 is a schematic illustration of a simplified block diagram of a video encoder in accordance with an embodiment of this disclosure;

FIG. 8A and FIG. 8B illustrates angle-preserving predictive coding;

FIG. 9A and FIG. 9B illustrates an example mechanism for mesh encoding/decoding across a 3D domain and a 2D domain;

FIG. 10A and FIG. 10B illustrates an example mechanism for mesh encoding/decoding across a 3D domain and a 2D domain;

FIG. 11A and FIG. 11B illustrates another example mechanism for mesh encoding/decoding across a 3D domain and a 2D domain;

FIG. 12A and FIG. 12B illustrates yet another example mechanism for mesh encoding/decoding across a 3D domain and a 2D domain;

FIG. 13 shows an example flow chart for decoding a 3D mesh;

FIG. 14 illustrate an example flow chart for encoding a 3D mesh;

FIG. 15 illustrates another example flow chart for encoding a 3D mesh; and

FIG. 16 is a schematic illustration of an example computer system in accordance with an embodiment.

### DETAILED DESCRIPTION OF EMBODIMENTS

Throughout this specification and claims, terms may have nuanced meanings suggested or implied in context beyond an explicitly stated meaning. The phrase “in one embodiment” or “in some embodiments” as used herein does not necessarily refer to the same embodiment and the phrase “in another embodiment” or “in other embodiments” as used herein does not necessarily refer to a different embodiment. Likewise, the phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments/implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

Technological developments in 3D media processing, such as advances in 3D capture, 3D modeling, and 3D rendering, and the like have promoted the ubiquitous creation of 3D contents across several platforms and devices. Such 3D contents contain information that may be processed to generate various forms of media to provide, for example, immersive viewing/rendering and interactive experience. Applications of 3D contents are abundant, including but not limited to virtual reality, augmented reality, metaverse interactions, gaming, immersive video conferencing, robotics, computer-aided design (CAD), and the like. According to an aspect of this disclosure, in order to improve immersive experience, 3D models are becoming ever more sophisticated, and the creation and consumption of 3D models demand a significant amount of data resources, such as data storage, data transmission resources, and data processing resources.

In comparison to traditional 2-dimensional (2D) contents that are generally represented by datasets in the form of 2D pixel arrays (such as images), 3D contents with three-dimensional full-resolution pixilation may be prohibitively resource intensive and are nevertheless unnecessary in many if not most practical applications. In most 3D immersive applications, according to some aspects of the disclosure, less data intensive representations of 3D contents may be employed. For example, in most applications, only topographical information rather than volumetric information of objects in a 3D scene (either real-world scene captured by sensors such as LIDAR devices or an animated 3D scene generated by software tools) may be necessary. As such, datasets in more efficient forms may be used to represent 3D objects and 3D scenes. For example, 3D meshes may be used as a type of 3D models to represent immersive 3D contents, such as 3D objects in 3D scenes.

A mesh (alternatively referred to as mesh model) of one or more objects may include a collection of vertices. The vertices may connect to one another to form edges. The edges may further connect to form faces. The faces may further form polygons. 3D surfaces of various objects may be decomposed into, for example, faces and polygons. Each of the vertices, edges, faces, polygons, or surfaces may be associated with various attributes such as color, surface normal, texture, and the like. A normal for a surface may be referred as the surface normal; and/or the normal for a vertex may be referred as the vertex normal. The information of how the vertices are connected into edges, faces or polygons may be referred to as connectivity information. The connectivity information is important for uniquely defining components of a mesh since the same set of vertices can form different faces, surfaces, and polygons. In general, a position of a vertex in the 3D space may be represented by its 3D coordinates. A face may be represented by a set of sequentially connected vertices, each associated with a set of 3D coordinates. Likewise, an edge may be represented by two vertices each associated with its 3D coordinates. The vertices, edges, and faces may be indexed in the 3D mesh datasets.

A mesh may be defined and described by a collection of one or more of these fundamental element types. However, not all types of elements above are necessary in order to fully describe a mesh. For example, a mesh may be fully described by using just vertices and their connectivity. For another example, a mesh may be fully described by just using a list of faces and common vertices of faces. As such, a mesh can be of various alternative types described by alternative dataset compositions and formats. Example mesh types include but are not limited to face-vertex meshes, winged-edge meshes, half-edge meshes, quad-edge meshes, corner-table meshes, vertex-vertex meshes, and the like. Correspondingly, a mesh dataset may be stored with information in compliance with alternative file formats with file extensions including but not limited to .raw, .blend, .fbx, .3ds, .dae, .dng, 3dm, .dsf, .dwg, .obj, .ply, .pmd, .stl, amf, .wrl, .wrz, .x3d, .x3db, .x3dv, .x3dz, .x3dbz, .x3dvz, .c4d, .lwo, .smb, .msh, .mesh, .veg, .z3d, .vtk, .14d, and the like. Attributes for these elements, such as color, surface normal, texture, and the like may be included into a mesh dataset in various manners.

In some implementations, vertices of a mesh may be mapped into a pixelated 2D space, referred to as a UV space. As such, each vertex of the mesh may be mapped to a pixel in the UV space. In some implementations, one vertex may be mapped to more than one pixel in the UV space, for example, a vertex at a boundary may be mapped to two or three pixels in the UV space. Likewise, a face or surface in the mesh may be sampled into a plurality of 3D points that may or may not be among recorded vertices in the mesh, and these plurality of 3D points may be also mapped to pixels in the 2-dimensional UV space. Mapping the vertices and sampled 3D points of faces or surfaces in a mesh into the UV space and the subsequent data analytics and processing in the UV space may facilitate data storage, compression, and coding of 3D dataset of a mesh or a sequence of mesh. A mapped UV space dataset may be referred to as a UV image, or 2D map, or a 2D image of the mesh.

While the example implementations above focus on a mesh that is static, according to an aspect of the disclosure, 3D meshes may be dynamic. A dynamic mesh, for example, may refer to a mesh where at least one of the components (geometry information, connectivity information, mapping information, vertex attributes and attribute maps) varies with time. As such, a dynamic mesh can be described by a sequence of meshes or meshes (also referred to as mesh frames), analogous to a timed sequence of 2D image frames that form a video.

In some example implementations, a dynamic mesh may have constant connectivity information, time varying geometry and time varying vertex attributes. In some other examples, a dynamic mesh can have time varying connectivity information. In some examples, digital 3D content creation tools may be used to generate dynamic meshes with time varying attribute maps and time varying connectivity information. In some other examples, volumetric acquisition/detection/sensing techniques are used to generate dynamic meshes. The volumetric acquisition techniques can generate a dynamic mesh with time varying connectivity information especially under real-time constraints.

A dynamic mesh may require a large amount of data since the dynamic mesh may include a significant amount of information changing over time. However, compression may be performed to take advantage of redundancies within a mesh frame (intra-compression) and between mesh frames (inter-compression). Various mesh compression processes may be implemented to allow efficient storage and transmission of media contents in the mesh representation, particularly for a mesh sequence.

Aspects of the disclosure provide example architectures and techniques for mesh compression. The techniques may be used for various mesh compression including but not limited to static mesh compression, dynamic mesh compression, compression of a dynamic mesh with constant connectivity information, compression of a dynamic mesh with time varying connectivity information, compression of a dynamic mesh with time varying attribute maps, and the like. The techniques may be used in lossy and lossless compression for various applications, such as real-time immersive communications, storage, free viewpoint video, augmented reality (AR), virtual reality (VR), and the like. The applications can include functionalities such as random access and scalable/progressive coding.

While this disclosure explicitly describes techniques and implementations applicable to 3D meshes, the principles underlying the various implementations described herein are applicable to other types of 3D data structures, including but not limited to Point Cloud (PC) data structures. For simplicity, references to 3D meshes below are intended to be general and include other type of 3D representations such as point clouds and other 3D volumetric datasets.

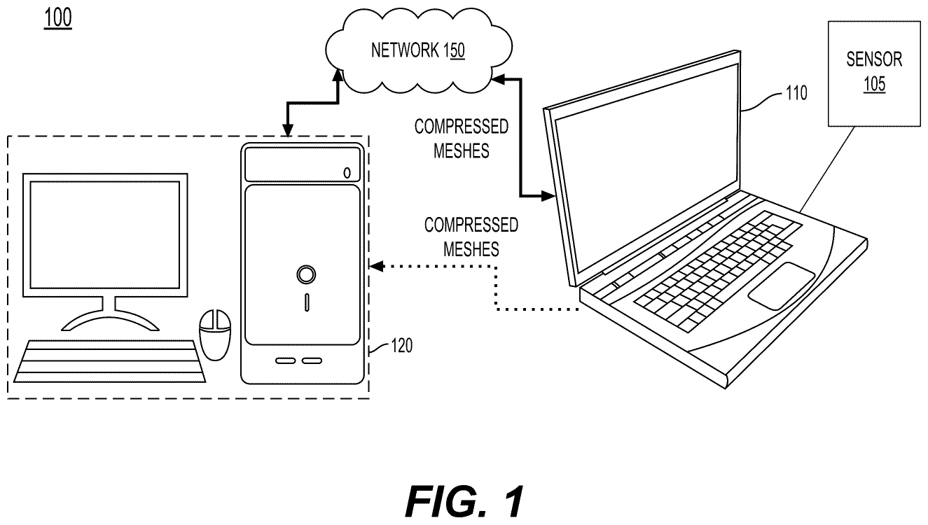

Turning first to example architectural level implementations, FIG. 1 illustrates a simplified block diagram of a communication system (100) according to an example embodiment of the present disclosure. The communication system (100) may include a plurality of terminal devices that can communicate with one another, via, for example, a communication network (150) (alternatively referred to as a network). For example, the communication system (100) may include a pair of terminal devices (110) and (120) interconnected via the network (150). In the example of FIG. 1, the first pair of terminal devices (110) and (120) may perform unidirectional transmission of 3D meshes. For example, the terminal device (110) may compress a 3D mesh or a sequence of 3D meshes, which may be generated by the terminal device (110) or obtained from a storage or captured by a 3D sensor (105) connected with the terminal device (110). The compressed 3D mesh or sequence of 3D meshes may be transmitted, for example in the form of a bitstream (also referred as a coded bitstream), to the other terminal device (120) via the network (150). The terminal device (120) may receive the compressed 3D mesh or sequence of 3D meshes from the network (150), decompress the bitstream to reconstruct the original 3D mesh or sequence of 3D meshes, and suitably process the reconstructed 3D mesh or sequence of 3D meshes for display or for other purposes/uses. Unidirectional data transmission may be common in media serving applications and the like.

In the example of FIG. 1, either one or both of the terminal devices (110) and (120) may be implemented as servers, fixed or mobile personal computers, laptop computers, tablet computers, smart phones, gaming terminals, media players, and/or dedicated three-dimensional (3D) equipment and the like, but the principles of the present disclosure may be not so limited. The network (150) may represent any type of network or combination of networks that transmit compressed 3D meshes between the terminal devices (110) and (120). The network (150) can include, for example, wireline (wired) and/or wireless communication networks. The network (150) may exchange data in circuit-switched and/or packet-switched channels. Representative networks include long-haul telecommunications networks, local area networks, wide area networks, cellular networks, and/or the Internet. For the purposes of the present disclosure, the architecture and topology of the network (150) may be immaterial to the operation of the present disclosure unless explained herein below.

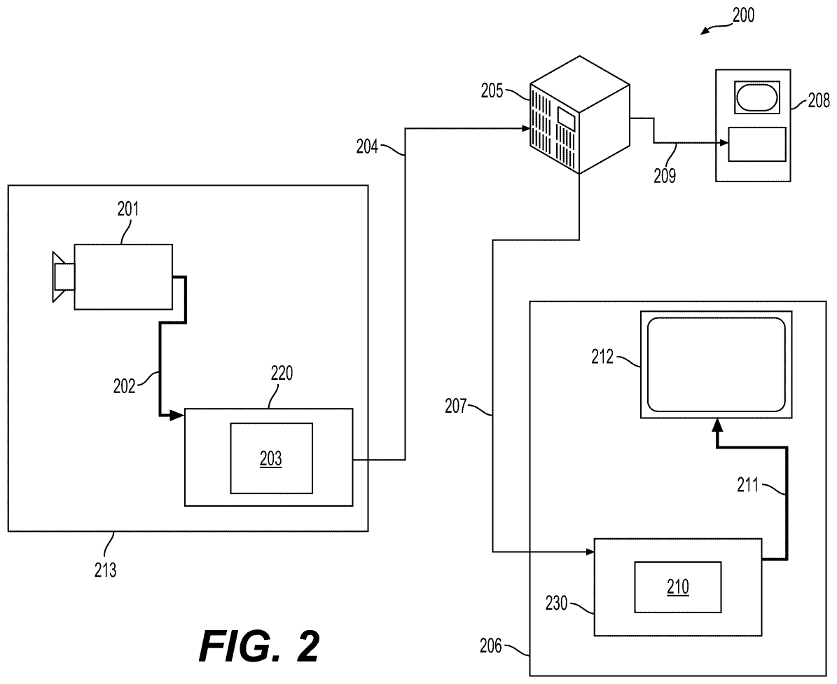

FIG. 2 illustrates an example simplified block diagram of a streaming system (200) in accordance with an embodiment of this disclosure. The FIG. 2 illustrates an example application for the disclosed implementations related to 3D meshes and compressed 3D meshes. The disclosed subject matter can be equally applicable to other 3D mesh or point cloud enabled applications, such as, 3D telepresence application, virtual reality application, and the like.

The streaming system (200) may include a capture or storage subsystem (213). The capture or storage subsystem (213) may include 3D mesh generator or storage medium (201), e.g., a 3D mesh or point cloud generation tool/software, a graphics generation component, or a point cloud sensor such as a light detection and ranging (LIDAR) systems, 3D cameras, 3D scanners, a 3D mesh store and the like that generate or provide 3D mesh (202) or point clouds (202) that are uncompressed. In some example implementations, the 3D meshes (202) include vertices of a 3D mesh or 3D points of a point cloud (both referred to as 3D mesh). The 3D meshes (202), depicted as a bold line to emphasize a corresponding high data volume when compared to compressed 3D meshes (204) (a bitstream of compressed 3D meshes). The compressed 3D meshes (204) may be generated by an electronic device (220) that includes an encoder (203) coupled to the 3D meshes (202). The encoder (203) can include hardware, software, or a combination thereof to enable or implement aspects of the disclosed subject matter as described in more detail below. The compressed 3D meshes (204) (or bitstream of compressed 3D meshes (204)), depicted as a thin line to emphasize the lower data volume when compared to the stream of uncompressed 3D meshes (202), can be stored in a streaming server (205) for future use. One or more streaming client subsystems, such as client subsystems (206) and (208) in FIG. 2 can access the streaming server (205) to retrieve copies (207) and (209) of the compressed 3D meshes (204). A client subsystem (206) may include a decoder (210), for example, in an electronic device (230). The decoder (210) may be configured to decode the incoming copy (207) of the compressed 3D meshes and create an outgoing stream of reconstructed 3D meshes (211) that can be rendered on a rendering device (212) or for other uses.

It is noted that the electronic devices (220) and (230) can include other components (not shown). For example, the electronic device (220) can include a decoder (not shown) and the electronic device (230) can include an encoder (not shown) as well.

In some streaming systems, the compressed 3D meshes (204), (207), and (209) (e.g., bitstreams of compressed 3D meshes) can be compressed according to certain standards. In some examples, as described in further detail below, video coding standards are used to take advantage of redundancies and correlations in the compression of 3D meshes after the 3D mesh is first projected to mapped into 2D representations suitable for video compression. Non-limiting examples of those standards include, High Efficiency Video Coding (HEVC), Versatile Video Coding (VVC), and the like, as described in further detail below.

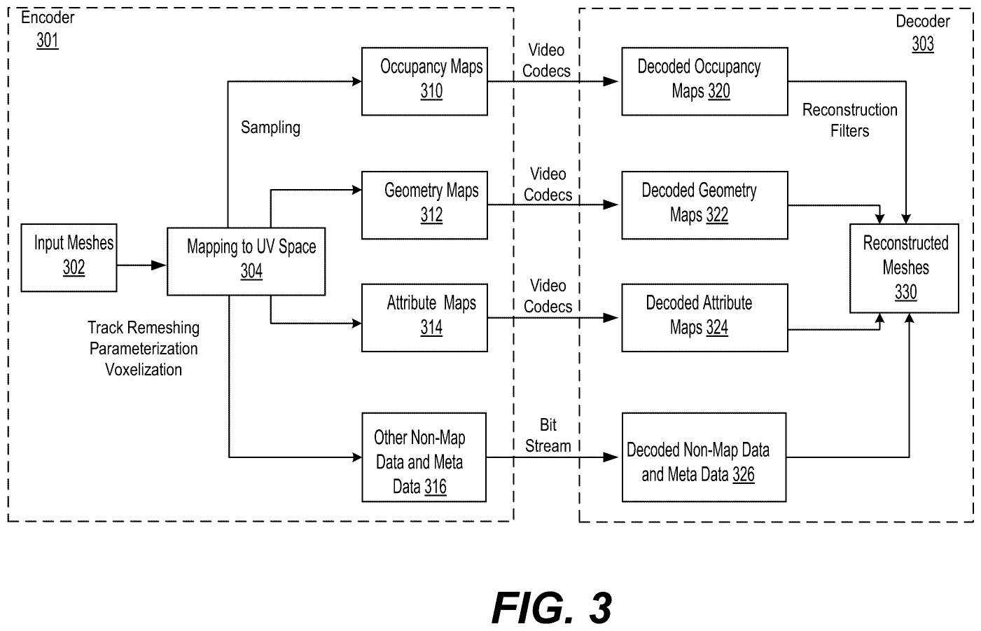

The compressed 3D mesh or sequence of 3D meshes may be generated by an encoder whereas a decoder may be configured to decompress the compressed or coded 3D meshes. FIG. 3 illustrates a high-level example data flow of 3D meshes in such an encoder (301) and decoder (303). As shown in FIG. 3, a raw input 3D mesh or a sequence of 3D meshes (302) may be preprocessed by track remeshing, parameterization, and/or voxelization to generate input data to a mapping unit for mapping the 3D meshes to a 2D UV space (304), which, in some implementations, may include meshes with UV atlas. The 3D meshes may be sampled to include 3D surface points that may not be among the vertices and add these sampled 3D surface points in the mapping to the UV space. Various 2D maps may be generated in the encoder 301, including but not limited to occupancy maps (310), geometry maps (312), attribute maps (314). These image type of maps may be compressed by the encoder 301 using, for example, video coding/compression technologies. For example, a video coder may help compressing a 3D mesh frame using intra-prediction techniques and inter-prediction by other 3D mesh reference frames. Other non-image or non-map data or meta data (316) may also be coded in various manner to remove redundancies to generate compressed non-map data, for non-limiting example, via entropy coding. The encoder 301 may then combine or multiplex the compressed 2D maps and non-map data and further coding the combined data to generate an encoded bitstream (alternatively referred as coded bitstream). The encoded bitstream may then be stored or transmitted for use by the decoder 303. The decoder may be configured to decode the bitstream, demultiplex the decoded bitstream to obtain the compressed 2D maps and non-map data, and preform decompression to generate decoded occupancy maps (320), decoded geometry maps (322), decoded attribute maps (324), and decoded non-map data and meta data (326). The decoder 303 may then further be configured to reconstruct the 3D mesh or sequence of 3D meshes (330) from the decoded 2D maps (320, 322, and 324) and decoded non-map data (326).

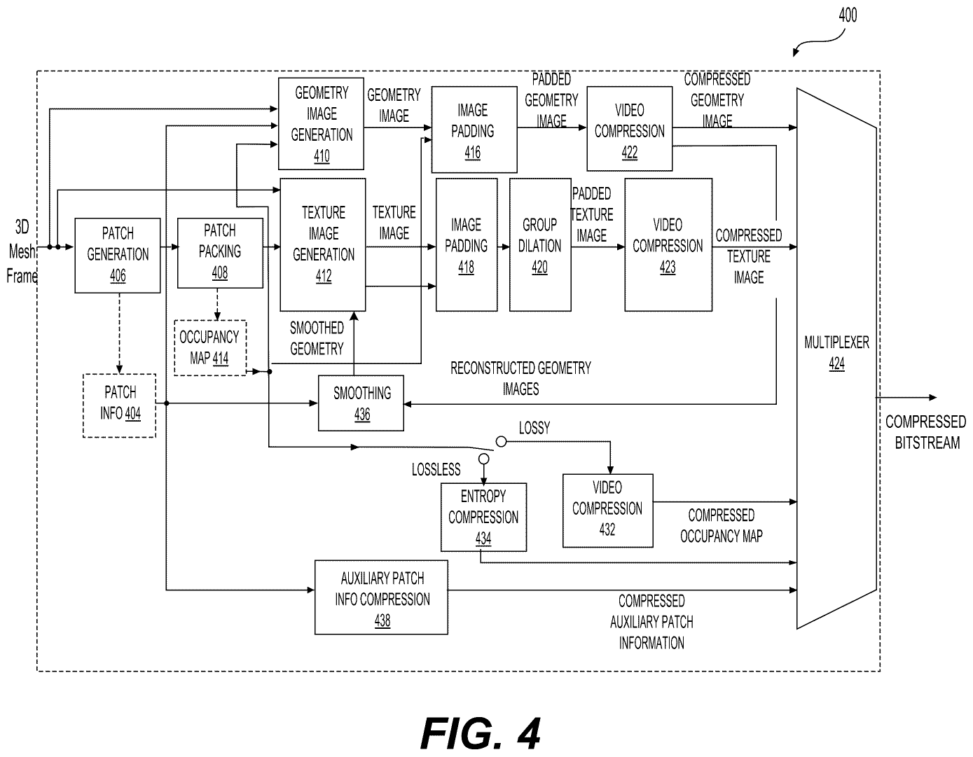

In further detail, FIG. 4 shows a block diagram of an example 3D mesh encoder (400) for encoding 3D mesh frames, according to some embodiments of this disclosure. In some example implementations, the mesh encoder (400) may be used in the communication system (100) and streaming system (200). For example, the encoder (203) can be configured and operate in a similar manner as the mesh encoder (400).

The mesh encoder (400) may receive 3D mesh frames as uncompressed inputs and generate bitstream corresponding to compressed 3D mesh frames. In some example implementations, the mesh encoder (400) may receive the 3D mesh frames from any source, such as the mesh or point cloud source (201) of FIG. 2 and the like.

In the example of FIG. 4, the mesh encoder (400) may include a patch generation module (406) (alternatively referred to chart generation module), a patch packing module (408), a geometry image generation module (410), a texture image generation module (412), a patch info module (404), an occupancy map module (414), a smoothing module (436), image padding modules (416) and (418), a group dilation module (420), video compression modules (422), (423) and (432), an auxiliary patch info compression module (438), an entropy compression module (434), and a multiplexer (424).

In various embodiments in the present disclosure, a module may refer to a software module, a hardware module, or a combination thereof. A software module may include a computer program or part of the computer program that has a predefined function and works together with other related parts to achieve a predefined goal, such as those functions described in this disclosure. A hardware module may be implemented using processing circuitry and/or memory configured to perform the functions described in this disclosure. Each module can be implemented using one or more processors (or processors and memory). Likewise, a processor (or processors and memory) can be used to implement one or more modules. Moreover, each module can be part of an overall module that includes the functionalities of the module. The description here also may apply to the term module and other equivalent terms (e.g., unit).

According to an aspect of the disclosure, and as descried above, the mesh encoder (400), converts 3D mesh frames into image-based representations (e.g., 2D maps) along with some non-map meta data (e.g., patch or chart info) that is used to assist converting the compressed 3D mesh back into a decompressed 3D mesh. In some examples, the mesh encoder (400) may convert 3D mesh frames into 2D geometry maps or images, texture maps or images and occupancy maps or images, and then use video coding techniques to encode the geometry images, texture images and occupancy maps into a bitstream along with the meta data and other compressed non-map data. Generally, and as described above, a 2D geometry image is a 2D image with 2D pixels filled with geometry values associated with 3D points projected (the term “projected” is used to mean “mapped”) to the 2D pixels, and a 2D pixel filled with a geometry value may be referred to as a geometry sample. A texture image is a 2D image with pixels filled with texture values associated with 3D points projected to the 2D pixels, and a 2D pixel filled with a texture value may be referred to as a texture sample. An occupancy map is a 2D image with 2D pixels filled with values that indicate occupation or non-occupation by 3D points.

The patch generation module (406) segments a 3D mesh into a set of charts or patches (e.g., a patch is defined as a contiguous subset of the surface described by the 3D mesh or point cloud), which may or may not be overlapping, such that each patch may be described by a depth field with respect to a plane in 2D space (e.g., flattening of the surface such that deeper 3D points on the surface is further away from center of the corresponding 2D map). In some embodiments, the patch generation module (406) aims at decomposing the 3D mesh into a minimum number of patches with smooth boundaries, while also minimizing the reconstruction error.

The patch info module (404) can collect the patch information that indicates sizes and shapes of the patches. In some examples, the patch information can be packed into a data frame and then encoded by the auxiliary patch info compression module (438) to generate the compressed auxiliary patch information. The auxiliary patch compression may be implemented in various forms, including but not limited to various types of arithmetic coding.

The patch or chart packing module (408) may be configured to map the extracted patches onto a 2D grid of the UV space while minimize the unused space. In some example implementations, the pixels of the 2D UV space may granularized to blocks of pixels for mapping of the patches or charts. The block size may be predefined. For example, the block size may be M be M×M (e.g., 16×16). With such granularity, it may be guaranteed that every M×M block of the 2D UV grid is associated with a unique patch. In other words, each patch is mapped to the 2D UV space with a 2D granularity of M×M. Efficient patch packing can directly impact the compression efficiency either by minimizing the unused space or ensuring temporal consistency. Examples implementations of packing of the patches or charts into the 2D UV space are given in further detail below.

The geometry image generation module (410) can generate 2D geometry images associated with geometry of the 3D mesh at given patch locations in the 2D grid. The texture image generation module (412) can generate 2D texture images associated with texture of the 3D mesh at given patch locations in the 2D grid. The geometry image generation module (410) and the texture image generation module (412) essentially exploit the 3D to 2D mapping computed during the packing process above to store the geometry and texture of the 3D mesh as 2D images, as described above. In some implementations, in order to better handle the case of multiple points being projected to the same sample (e.g., the patches overlap in the 3D space of the mesh), the 2D image may be layered. In other words, each patch may be projected onto, e.g., two images, referred to as layers, such that the multiple points can be projected into the same points in the different layers.

In some example implementations, a geometry image may be represented by a monochromatic frame of width×height (W×H). As such, three geometry images of the 3 luma or chroma channels may be used to represents the 3D coordinates. In some example implementations, a geometry image may be represented by a 2D image having three channels (RGB, YUV, YCrCb, and the like) with a certain color depth (e.g., 8-bit, 12-bit, 16-bit, or the like). As such, one geometry image having the 3 color channels may be used to represents the 3D coordinates.

To generate the texture image, the texture generation procedure exploits the reconstructed/smoothed geometry in order to compute the colors to be associated with the sampled points from the original 3D mesh (see “sampling” of FIG. 3, which, for example, would generate 3D surface points not among the vertices of the original 3D mesh).

The occupancy map module (414) may be configured to generate an occupancy map that describes padding information at each unit. For example, as described above, the occupancy image may include a binary map that indicates for each cell of the 2D grid whether the cell belongs to the empty space or to the 3D mesh. In some example implementations, the occupancy map may use binary information to describe for each pixel whether the pixel is padded or not. In some other example implementations, the occupancy map may use binary information to describe for each block of pixels (e.g., each M×M block) whether the block of pixels is padded or not.

The occupancy map generated by the occupancy map module (414) may be compressed using lossless coding or lossy coding. When lossless coding is used, the entropy compression module (434) may be used to compress the occupancy map. When lossy coding is used, the video compression module (432) may be used to compress the occupancy map.

It is noted that the patch packing module (408) may leave some empty spaces between 2D patches packed in an image frame. The image padding modules (416) and (418) may fill the empty spaces (referred to as padding) in order to generate an image frame that may be suited for 2D video and image codecs. The image padding is also referred to as background filling which can fill the unused space with redundant information. In some examples, a well-implemented background filling minimally increases the bit rate while avoiding introducing significant coding distortion around the patch boundaries.

The video compression modules (422), (423), and (432) can encode the 2D images, such as the padded geometry images, padded texture images, and occupancy maps based on a suitable video coding standard, such as HEVC, VVC and the like. In some example implementations, the video compression modules (422), (423), and (432) are individual components that operate separately. It is noted that the video compression modules (422), (423), and (432) can be implemented as a single component in some other example implementations.

In some example implementations, the smoothing module (436) may be configured to generate a smoothed image of the reconstructed geometry image. The smoothed image can be provided to the texture image generation (412). Then, the texture image generation (412) may adjust the generation of the texture image based on the reconstructed geometry images. For example, when a patch shape (e.g. geometry) is slightly distorted during encoding and decoding, the distortion may be taken into account when generating the texture images to correct for the distortion in the patch shape.

In some embodiments, the group dilation (420) is configured to pad pixels around the object boundaries with redundant low-frequency content in order to improve coding gain as well as visual quality of reconstructed 3D mesh.

The multiplexer (424) may be configured to multiplex the compressed geometry image, the compressed texture image, the compressed occupancy map, the compressed auxiliary patch information into a compressed bitstream.

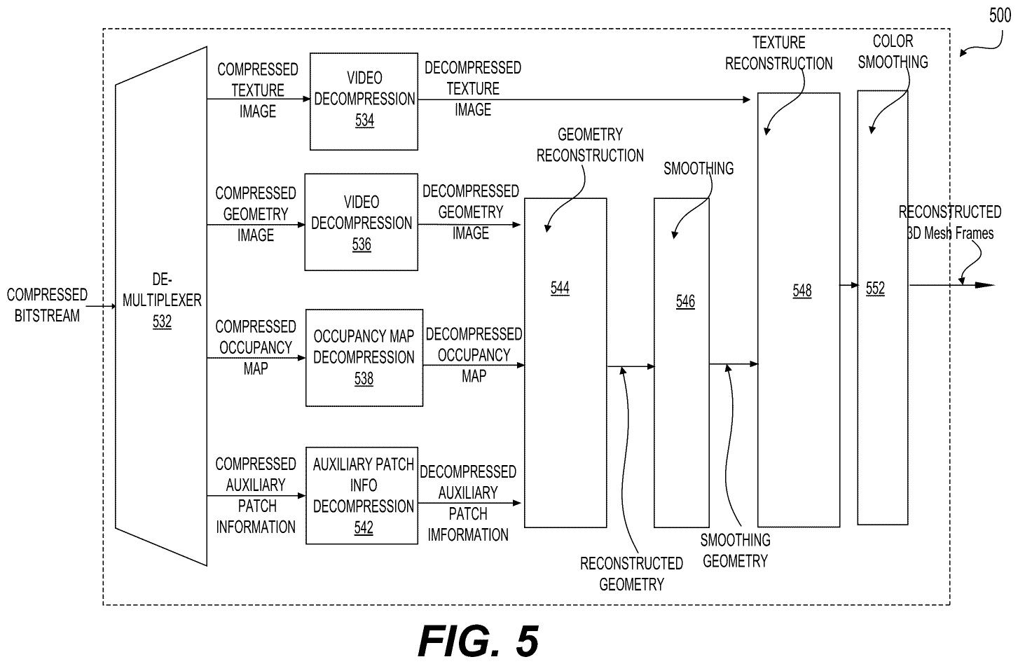

FIG. 5 shows a block diagram of an example mesh decoder (500) for decoding compressed bitstream corresponding to 3D mesh frames, according to some embodiments of this disclosure. In some example implementations, the mesh decoder (500) can be used in the communication system (100) and streaming system (200). For example, the decoder (210) can be configured to operate in a similar manner as the mesh decoder (500). The mesh decoder (500) receives the compressed bitstream, and generates reconstructed 3D meshes based on the compressed bitstream including, for example, the compressed geometry image, the compressed texture image, the compressed occupancy map, the compressed auxiliary patch information.

In the example of FIG. 5, the mesh decoder (500) may include a de-multiplexer (532), video decompression modules (534) and (536), an occupancy map decompression module (538), an auxiliary patch-information decompression module (542), a geometry reconstruction module (544), a smoothing module (546), a texture reconstruction module (548), and a color smoothing module (552).

The de-multiplexer (532) may receive and separate the compressed bitstream into compressed texture image, compressed geometry image, compressed occupancy map, and compressed auxiliary patch information.

The video decompression modules (534) and (536) can decode the compressed images according to a suitable standard (e.g., HEVC, VVC, etc.) and output decompressed images. For example, the video decompression module (534) may decode the compressed texture images and output decompressed texture images. The video decompression module (536) may further decode the compressed geometry images and outputs the decompressed geometry images.

The occupancy map decompression module (538) may be configured to decode the compressed occupancy maps according to a suitable standard (e.g., HEVC, VVC, etc.) and output decompressed occupancy maps.

The auxiliary patch-information decompression module (542) may be configured to decode the compressed auxiliary patch information according to a suitable decoding algorithm and output decompressed auxiliary patch information.

The geometry reconstruction module (544) may be configured to receive the decompressed geometry images, and generate reconstructed 3D mesh geometry based on the decompressed occupancy map and decompressed auxiliary patch information.

The smoothing module (546) may be configured to smooth incongruences at edges of patches. The smoothing procedure may be aimed at alleviating potential discontinuities that may arise at the patch boundaries due to compression artifacts. In some example implementations, a smoothing filter may be applied to the pixels located on the patch boundaries to alleviate the distortions that may be caused by the compression/decompression.

The texture reconstruction module (548) may be configured to determine texture information for points in the 3D meshes based on the decompressed texture images and the smoothing geometry.

The color smoothing module (552) may be configured to smooth incongruences of coloring. Non-neighboring patches in 3D space are often packed next to each other in 2D videos. In some examples, pixel values from non-neighboring patches might be mixed up by the block-based video codec. The goal of color smoothing may be to reduce the visible artifacts that appear at patch boundaries.

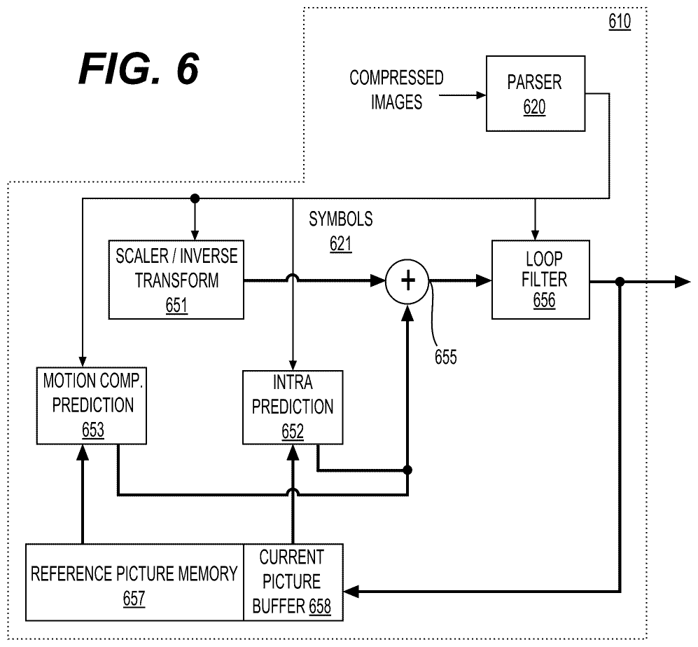

FIG. 6 shows a block diagram of an example video decoder (610) according to an embodiment of the present disclosure. The video decoder (610) may be used in the mesh decoder (500). For example, the video decompression modules (534) and (536), the occupancy map decompression module (538) may be similarly configured as the video decoder (610).

The video decoder (610) may include a parser (620) to reconstruct symbols (621) from compressed images, such as the coded video sequence. Categories of those symbols may include information used to manage operation of the video decoder (610). The parser (620) may parse/entropy-decode the coded video sequence being received. The coding of the coded video sequence can be in accordance with a video coding technology or standard, and can follow various principles, including variable length coding, Huffman coding, arithmetic coding with or without context sensitivity, and so forth. The parser (620) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (620) may also extract from the coded video sequence information such as transform coefficients, quantizer parameter values, motion vectors, and so forth.

The parser (620) may perform an entropy decoding/parsing operation on the image sequence received from a buffer memory, so as to create symbols (621).

Reconstruction of the symbols (621) can involve multiple different units depending on the type of the coded video picture or parts thereof (such as: inter and intra picture, inter and intra block), and other factors. Which units are involved, and how, may be controlled by the subgroup control information that was parsed from the coded video sequence by the parser (620). The flow of such subgroup control information between the parser (620) and the multiple units below is not depicted for clarity.

Beyond the functional blocks already mentioned, the video decoder (610) can be conceptually subdivided into a number of functional units as described below. In a practical implementation operating under commercial constraints, many of these units interact closely with each other and can, at least partly, be integrated into each other. The conceptual subdivision into the functional units below is made merely for the purpose of describing the disclosed subject matter.

The video decoder (610) may include a scaler/inverse transform unit (651). The scaler/inverse transform unit (651) may receive a quantized transform coefficient as well as control information, including which transform to use, block size, quantization factor, quantization scaling matrices, etc. as symbol(s) (621) from the parser (620). The scaler/inverse transform unit (651) may output blocks comprising sample values that can be input into aggregator (655).

In some cases, the output samples of the scaler/inverse transform (651) can pertain to an intra coded block; that is: a block that is not using predictive information from previously reconstructed pictures, but can use predictive information from previously reconstructed parts of the current picture. Such predictive information can be provided by an intra picture prediction unit (652). In some cases, the intra picture prediction unit (652) may generate a block of the same size and shape of the block under reconstruction, using surrounding already reconstructed information fetched from the current picture buffer (658). The current picture buffer (658) may buffer, for example, partly reconstructed current picture and/or fully reconstructed current picture. The aggregator (655), in some cases, may add, on a per sample basis, the prediction information that the intra prediction unit (652) has generated to the output sample information as provided by the scaler/inverse transform unit (651).

In other cases, the output samples of the scaler/inverse transform unit (651) can pertain to an inter coded, and potentially motion compensated block. In such a case, a motion compensation prediction unit (653) can access reference picture memory (657) to fetch samples used for prediction. After motion compensating the fetched samples in accordance with the symbols (621) pertaining to the block, these samples may be added by the aggregator (655) to the output of the scaler/inverse transform unit (651) (in this case called the residual samples or residual signal) so as to generate output sample information. The addresses within the reference picture memory (657) from where the motion compensation prediction unit (653) fetches prediction samples can be controlled by motion vectors, available to the motion compensation prediction unit (653) in the form of symbols (621) that can have, for example X, Y, and reference picture components. Motion compensation also may include interpolation of sample values as fetched from the reference picture memory (657) when sub-sample exact motion vectors are in use, motion vector prediction mechanisms, and so forth.

The output samples of the aggregator (655) may be subject to various loop filtering techniques in the loop filter unit (656). Video compression technologies may include in-loop filter technologies that are controlled by parameters included in the coded video sequence (also referred to as coded video bitstream) and made available to the loop filter unit (656) as symbols (621) from the parser (620), but may also be responsive to meta-information obtained during the decoding of previous (in decoding order) parts of the coded picture or coded video sequence, as well as responsive to previously reconstructed and loop-filtered sample values.

The output of the loop filter unit (656) may be a sample stream that can be output to a render device as well as stored in the reference picture memory (657) for use in future inter-picture prediction.

Certain coded pictures, once fully reconstructed, may be used as reference pictures for future prediction. For example, once a coded picture corresponding to a current picture is fully reconstructed and the coded picture has been identified as a reference picture (by, for example, the parser (620)), the current picture buffer (658) may become a part of the reference picture memory (657), and a fresh current picture buffer may be reallocated before commencing the reconstruction of the following coded picture.

The video decoder (610) may perform decoding operations according to a predetermined video compression technology in a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile may select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

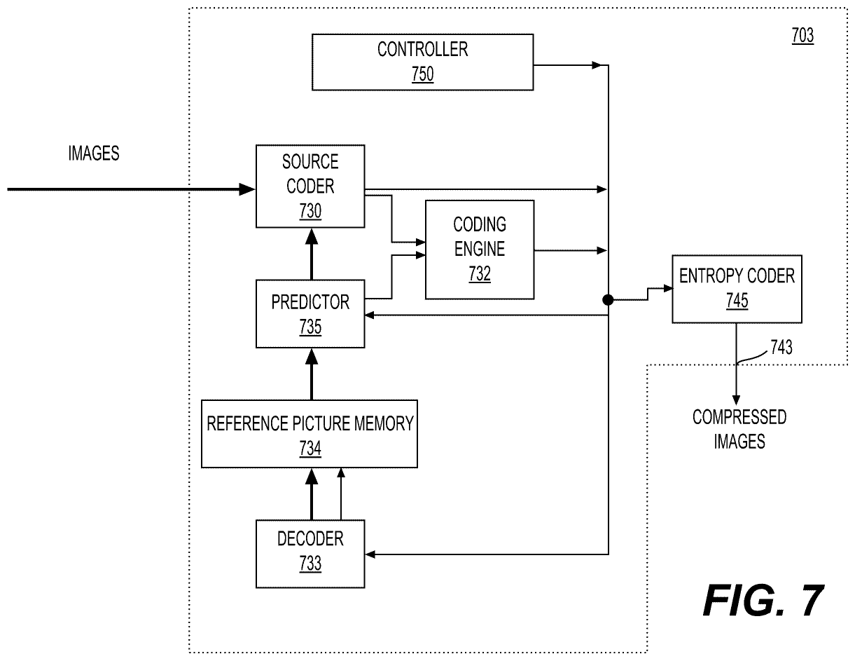

FIG. 7 shows a block diagram of a video encoder (703) according to an embodiment of the present disclosure. The video encoder (703) can be used in the mesh encoder (400) that compresses 3D meshes or point clouds. In some example implementations, the video compression module (422) and (423), and the video compression module (432) are configured similarly to the encoder (703).

The video encoder (703) may receive 2D images, such as padded geometry images, padded texture images and the like, and generate compressed images.

According to an example embodiment of this disclosure, the video encoder (703) may code and compress the pictures of the source video sequence (images) into a coded video sequence (compressed images) in real-time or under any other time constraints as required by the application. Enforcing appropriate coding speed is one function of a controller (750). In some embodiments, the controller (750) controls other functional units as described below and is functionally coupled to the other functional units. The coupling is not depicted for clarity. Parameters set by the controller (750) can include rate control related parameters (picture skip, quantizer, lambda value of rate-distortion optimization techniques, . . . ), picture size, group of pictures (GOP) layout, maximum motion vector search range, and so forth. The controller (750) may be configured to have other suitable functions that pertain to the video encoder (703) optimized for a certain system design.

In some example implementations, the video encoder (703) may be configured to operate in a coding loop. As an oversimplified description, in an example, the coding loop may include a source coder (730) (e.g., responsible for creating symbols, such as a symbol stream, based on an input picture to be coded, and a reference picture(s)), and a (local) decoder (733) embedded in the video encoder (703). The decoder (733) may reconstruct the symbols to create the sample data in a similar manner as a (remote) decoder also would create (as any compression between symbols and coded video bitstream is lossless in the video compression technologies considered in the disclosed subject matter). The reconstructed sample stream (sample data) may be input to the reference picture memory (734). As the decoding of a symbol stream leads to bit-exact results independent of decoder location (local or remote), the content in the reference picture memory (734) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (733) can be the same as of a “remote” decoder, such as the video decoder (610), which has already been described in detail above in conjunction with FIG. 6. Briefly referring also to FIG. 6, however, as symbols are available and encoding/decoding of symbols to a coded video sequence by an entropy coder (745) and the parser (620) can be lossless, the entropy decoding parts of the video decoder (610), including and parser (620) may not be fully implemented in the local decoder (733).

In various embodiments in the present disclosure, any decoder technology except the parsing/entropy decoding that is present in a decoder also may necessarily needs to be present, in substantially identical functional form, in a corresponding encoder. For this reason, the disclosed subject matter focuses on decoder operation. The description of encoder technologies may be abbreviated as they are the inverse of the comprehensively described decoder technologies. Only in certain areas a more detail description is required and provided below.

During operation, in some examples, the source coder (730) may perform motion compensated predictive coding, which codes an input picture predictively with reference to one or more previously-coded picture from the video sequence that were designated as “reference pictures”. In this manner, the coding engine (732) may code differences between pixel blocks of an input picture and pixel blocks of reference picture(s) that may be selected as prediction reference(s) to the input picture.

The local video decoder (733) may decode coded video data of pictures that may be designated as reference pictures, based on symbols created by the source coder (730). Operations of the coding engine (732) may advantageously be lossy processes. When the coded video data may be decoded at a video decoder (not shown in FIG. 7), the reconstructed video sequence typically may be a replica of the source video sequence with some errors. The local video decoder (733) replicates decoding processes that may be performed by the video decoder on reference pictures and may cause reconstructed reference pictures to be stored in the reference picture cache (734). In this manner, the video encoder (703) may store copies of reconstructed reference pictures locally that have common content as the reconstructed reference pictures that will be obtained by a far-end video decoder (absent transmission errors).

The predictor (735) may perform prediction searches for the coding engine (732). That is, for a new picture to be coded, the predictor (735) may search the reference picture memory (734) for sample data (as candidate reference pixel blocks) or certain metadata such as reference picture motion vectors, block shapes, and so on, that may serve as an appropriate prediction reference for the new pictures. The predictor (735) may operate on a sample block-by-pixel block basis to find appropriate prediction references. In some cases, as determined by search results obtained by the predictor (735), an input picture may have prediction references drawn from multiple reference pictures stored in the reference picture memory (734).

The controller (750) may manage coding operations of the source coder (730), including, for example, setting of parameters and subgroup parameters used for encoding the video data.

Output of all aforementioned functional units may be subjected to entropy coding in the entropy coder (745). The entropy coder (745) may translate the symbols as generated by the various functional units into a coded video sequence, by lossless compressing the symbols according to technologies such as Huffman coding, variable length coding, arithmetic coding, and so forth.

The controller (750) may manage operation of the video encoder (703). During coding, the controller (750) may assign to each coded picture a certain coded picture type, which may affect the coding techniques that may be applied to the respective picture. For example, pictures often may be assigned as one of the following picture types:

An Intra Picture (I picture) may be one that may be coded and decoded without using any other picture in the sequence as a source of prediction. Some video codecs allow for different types of intra pictures, including, for example Independent Decoder Refresh (“IDR”) Pictures. A person skilled in the art is aware of those variants of I pictures and their respective applications and features.

A predictive picture (P picture) may be one that may be coded and decoded using intra prediction or inter prediction using at most one motion vector and reference index to predict the sample values of each block.

A bi-directionally predictive picture (B Picture) may be one that may be coded and decoded using intra prediction or inter prediction using at most two motion vectors and reference indices to predict the sample values of each block. Similarly, multiple-predictive pictures can use more than two reference pictures and associated metadata for the reconstruction of a single block.

The video encoder (703) may perform coding operations according to a predetermined video coding technology or standard, such as ITU-T Rec. H.265. In its operation, the video encoder (703) may perform various compression operations, including predictive coding operations that exploit temporal and spatial redundancies in the input video sequence. The coded video data, therefore, may conform to a syntax specified by the video coding technology or standard being used.

A video may be in the form of a plurality of source pictures (images) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some embodiments, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

In various embodiments, the mesh encoder (400) and the mesh decoder (500) above can be implemented with hardware, software, or combination thereof. For example, the mesh encoder (400) and the mesh decoder (500) can be implemented with processing circuitry such as one or more integrated circuits (ICs) that operate with or without software, such as an application specific integrated circuit (ASIC), field programmable gate array (FPGA), and the like. In another example, the mesh encoder (400) and the mesh decoder (500) can be implemented as software or firmware including instructions stored in a non-volatile (or non-transitory) computer-readable storage medium. The instructions, when executed by processing circuitry, such as one or more processors, causing the processing circuitry to perform functions of the mesh encoder (400) and/or the mesh decoder (500).

As described above, a raw 3D mesh or a portion/component of a raw 3D mesh may include a set of 3D vertices, also referred to as 3D geometry vertices, each vertex being associated with a 3D position in a 3D space (e.g., position or coordinate of each point in a point cloud). These 3D vertices may be connected to form edges and faces. The 3D mesh thus may also contain data indicating how these 3D geometry vertices are connected, referred to as connectivity of the 3D vertices. Similarly, a 2D mapping of the 3D mesh, such as a 2D texture mapping also includes a set of 2D points, referred to as 2D coordinates that map to the 3D geometric vertices. The mapping between the 3D geometry vertices to the 2D coordinates may be one-to-one or one-to-many because one 3D geometry vertex may belong to more than one edges or faces, which when projected into a 2D UV space, may be spatially separated. The 2D mapping may also contain connectivity information between the 2D coordinates. Such 2D connectivity may not be the same as but may bear correlation with the 3D connectivity. In the various disclosure below, 2D texture mapping and corresponding 2D texture coordinates are used as example. The underlying principles apply to any other types of 2D mapping.

In some example implementations for compression of the 3D positions, the 3D geometry vertices may be progressively scanned by the encoder and a position of a next 3D geometry vertex may be predictively encoded by one or more previous 3D geometry vertexes. The encoder may reconstruct (just like what a decoder would do) the one or more previous 3D geometry vertices already encoded to obtain reconstructed positions (represented by 3D coordinates) and use these reconstructed 3D positions to generate a predictor for the position of the next 3D geometry vertex. The encoder may then identify the actual 3D position of this next 3D geometry vertex and code it as, for example, a residual against the predictor. The residual tends to be small in value statistically, taking advantage of the correlation between position of a 3D geometry vertex to its neighbours. Likewise, 2D coordinates of the 2D textual mapping may be coded in a similar fashion. In some specific implementations, the first vertex of the set of 3D geometry vertices or the first coordinate of the set of 2D coordinates of the 2D texture mapping may be predicted by a predefined position (e.g., by the 2D or 3D origin or by a signaled position); the reconstructed first position may be used to predict the position of the second 3D geometry vertex or 2D coordinate; the reconstructed positions of the first and second 3D geometry vertices or 2D coordinates may be used to predict a third 3D geometry vertex or 2D coordinate; the reconstructed positions of the first, second, and third 3D geometry vertices or 2D coordinates may be used to predict a fourth 3D geometry vertex or 2D coordinate; and finally and progressively, the reconstructed positions of the previous three 3D geometry vertices or 2D coordinates may be used to predict a next vertex or coordinate. In such example the steady-state number of previous 3D geometry vertices or 2D coordinates for predicting the next vertex or coordinate is three but that is non-limiting. Other numbers may be used. This process, for example may be repeated for each component of the 3D mesh. Alternatively, from mesh component to mesh component, one or more vertices or coordinates of a previous mesh component may be used to predict the first 3D vertex or 2D coordinate of the next mesh component.

Correspondingly, a decoder may progressively reconstruct one or more 3D geometry vertices or 2D coordinates, and then generate a predictor from these reconstructed one or more 3D vertices or 2D coordinates, and then extract the residual for the next 3D geometry vertex or 2D texture coordinate and reconstruct the position of the next 3D geometry vertex or 2D coordinate from the predictor and the extracted residual.

In some example implementations, the connectivity information within the 3D geometric vertices and within the 2D coordinates and other attributes such as normal vectors may further be separately encoded. For example, different datasets for, i.e., 3D positions of the 3D geometry vertices, the connectivity within the 3D geometry vertices, the 2D positions of the 2D coordinates, the connectivity within the 2D coordinates, and other attributes may be separately and independent coded. Each of these datasets may be encoded in any order. In some other example implementations, encoding of one of these datasets may depend on another of these datasets, thereby leveraging inter-dataset (or inter-domain) correlations in a 3D mesh. For example, information in one of these datasets may be considered in generating predictors in another dataset. In such example implementations, the order in which these datasets are encoded or decoded would be correspondingly restricted because of such dependencies.

In some example mesh encoding implementations, such as Static Polygon Mesh Coding/Compression (SPMC), Video based Dynamic Mesh Coding/Compression (V-DMC), and Polygon Mesh Coding/Compression (PMC), an encoding order may be (1) 3D positions and their connectivity, followed by (2) 2D texture coordinates and their connectivity, and finally (3) other attributes like normal vectors. Such encoding order and corresponding decoding order may thus only allow certain inter data set coding dependency. For example, in the coding order above, the 3D position would be compressed independent of other datasets because it is compressed first. In some situations involving complex surface geometries, encoding of 3D positions may be less efficient without considering position information in the corresponding 2D texture map (e.g., predictor generation during the compression process may be less accurate, leading to larger or less efficient residuals).

In some example implementations, encoding of 3D positions within the 3D position dataset may first utilizes neighboring 3D position information for linear predictions as described above, such as using three neighboring positions and a parallelogram prediction method. The 3D information may then be used for coding of potions of 2D coordinates in 2D mapping, potentially enabling more efficient coding of the positions and/or connectivity of the 2D coordinates.

For example, the 2D texture coordinates, which, as described above, map 2D textures onto 3D surfaces, may be generated to preserve distances and angles, thereby minimizing rendering distortion. By encoding the 3D positions first, the subsequent encoding of connectivity and 2D texture coordinates may benefits from the correlation between the 3D positions and their 2D counterparts. Such implementation of coding 3D positions first may thus facilitate a more efficient compression and reduced data rate by projecting the encoded 3D positions onto a 2D plane, using a form of stretching prediction in 2D relying on the 3D information. Additionally, minimal information may be required to signal the connectivity for the 2D texture coordinates, which effectively represents the one-to-many mapping from 3D points to 2D points.

However, such a prediction approach of 3D positions first often assumes planar surfaces with 3D position predictors located in a same plane as the neighboring 3D positions used for generating the predictor, leading to limited performance in representing more complex geometries. Because of that assumption and linear/planner prediction, a significant portion of predictions made across different parts of the mesh in some situations tend to be inaccurate, particular for cross prediction or prediction of non-planer vertex (where the 3D geometry vertex to be predicted is out of plane of the neighboring 3D geometry vertices used to provide the prediction), leading to non-optimal residuals for 3D position coding. Thus, the overall coding efficiency by coding the 3D positions first may nevertheless be comprised even though there is benefit to the 2D coding.

In the further disclosure below, example implementations are described to first encode/decoding positions of 2D coordinates in a 2D mapping, particular 2D texture mapping, ahead of the encoding/decoding of 3D position of 3D geometry vertices, thereby leveraging 2D information in encoding 3D positions to improve 3D position coding efficiency, and in some situations improving overall coding efficiency of encoding/decoding of 3D and 2D positions.

Additionally in the disclosure below, further example implementations are described to provide an adaptive encoding/decoding order and dependency with respect to positions of 3D geometry vertices and 2D coordinates such that for some portions of the 3D mesh 2D coordinates are encoded/decoded first and 3D positions of the 3D geometry vertices are encoded/decoded afterwards and dependent on the 2D information, whereas in some other portions of the 3D mesh, 3D positions are encoded/decoded first and 2D coordinates are encoded/decoded afterwards and dependent on the 3D information. By providing such adaptivity, the encoding/decoding order and dependency can be varied during the encoding/decoding process according to data content and coding gain, thereby improving overall coding efficiency.

The disclosed method and devices in the example implementations below can enhance any triangular or polygonal mesh compression algorithm, as well as any approach used to encode the connectivity of a mesh model. The various implementations below may be used separately or in combination of any forms.

In some example implementations, the encoding/decoding of the 2D texture coordinates may be performed before the encoding of positions of the 3D geometry vertices so that the encoding/decoding of the 3D geometry vertices may depend on the 2D information for improving the coding efficiency of the 3D geometry vertices.

For example, the priority may be to encode the 2D texture coordinates and their connectivity in the bitstream before encoding the 3D positions. This sequence may be followed by the encoding of other attributes, such as normals (normal vectors). Correspondingly at the decoder, the 2D texture coordinates and their connectivity may be reconstructed first. Any 2D information that is needed for the following decoding of the 3D positions and connectivity may be available to the decoder. Such encoding/decoding methods and corresponding devices thus may take advantage of the intrinsic correlation between texture coordinates and 3D positions, which can be exploited to improve prediction accuracy and thus enhance the overall compression ratio.

In some further example implementations above, the compression ratio may be further improved by separating the encoding of connectivity from the encoding of positions, applying distinct strategies for 2D and 3D data. The followings are one example of encoding order of the 2D and 3D information from earliest to the latest (decoding order can be accordingly derived):

3D Connectivity Encoding: This example implementation begins by encoding the connectivity information for the 3D positions, which defines the structure of the mesh.

2D Texture Coordinate Connectivity Encoding: Following the 3D connectivity, the connectivity of the 2D texture coordinates is encoded. This step lays the groundwork for accurate texture mapping.

2D Position Encoding: The positions of the 2D texture coordinates may then be encoded using prediction methods such as parallelogram prediction, leveraging the already encoded connectivity data to generate predictions.

3D Position Encoding with, for example, 2D Mapping/Warping Prediction: Finally, the 3D positions may be encoded using a prediction method that maps or warps the 3D data based on the 2D texture coordinates. This method takes advantage of the correlation between the 2D and 3D data to improve compression. The warp of the 3D data in the prediction may provide more accurate prediction by not limiting to planer prediction.

In some alternative example implementations, position and connectivity encoding in either or both of 2D and 3D may be jointly rather than separately encoded/decoded, providing a more integrated approach. An example encoding/decoding order is shown below from the earliest to the latest (using encoding as illustration and decoding order can be correspondingly derived):

Encoding Connectivity and 2D Positions Simultaneously: The algorithm may be configured to encode the connectivity and 2D positions of texture coordinates in tandem. This simultaneous approach can help to exploit the spatial correlation between connectivity and texture mapping.

Seam Vertex Connection Encoding: The algorithm then encodes the seam vertex connection, which is essential for constructing the 3D connectivity. This step facilitates accurate reconstruction of the mesh structure.

Position Encoding with Stretch Prediction: The 3D positions may then be encoded using, for example, a warping prediction technique that maps the 2D texture coordinates back to the 3D positions. This prediction method may be designed to efficiently translate the 2D mapped data into the 3D space, capitalizing on the relationship between the 2D and 3D representations to minimize redundancy and enhance compression.

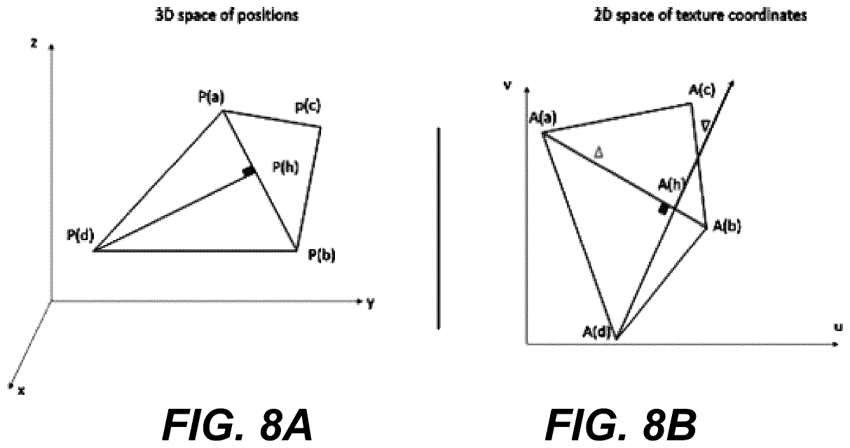

Further example implementations below provide manners in which 2D information is used to predict 3D positions. In these example implementations, 2D to 3D shape preserving position prediction may be used. Such cross-dataset prediction is referred to as shape preserving because such prediction utilizes shape-preserving properties of conformal and quasi-conformal mesh parameterizations. As an example, the prediction that preserved angles may be used. The angle-preserving properties facilitate a preservation of geometric relations between the 3D domain and the 2D parameterization domain. An example of angle-preserving prediction is shown in FIG. 8A and FIG. 8B in the 3D domain and 2D domain, respectively, showing

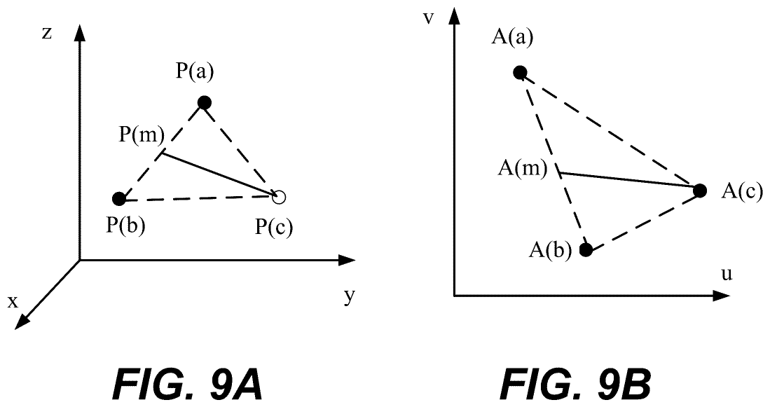

In some example implementations, two 3D vertex neighbors may be used to predict a position of the next 3D vertex with the help of the positions of the corresponding 2D texture coordinates. Specifically, consider a triangle defined by vertices a, b, and c of the 3D mesh, with their 3D geometry positions illustrated in FIG. 9A and their 2D positions in the 2D texture mapping illustrated in FIG. 9B. It may be assumed that the encoder and decoder are aware of (e.g., visited already, have reconstructed in the decoder, or in the decoding loop of an encoder):

The 3D positions P(a) and P(b) of vertices a and b, respectively; and

The 2D texture coordinates A(a), A(b), and A(c) for all three vertices a, b, and c.

The goal is to predict the 3D position P(c) for vertex c (represented by the open circle in FIG. 9A) using the known/reconstructed 3D positions P(a) and P(b) (in either the encoder or the decoder) and additionally using the reconstructed 2D texture coordinates A(a), A(b), and A(c) (in either the encoder or the decoder) in a shape-preserving manner. The reconstructed P(a), P(b), A(a), A(b), and A(c) would be the actual 3D and 2D positions if the compression is lossless.

In an example, the prediction candidate of 3D position is selected based on the best prediction candidate in 2D texture coordinate. However, unlike where 2D texture coordinate is predicted based on 3D position, the inverse process is performed and the prediction in 3D requires more information (because 3D position contains more information than the 2D coordinates). As such, a best prediction candidate may be selected. For example, the midpoint between P(a) and P(b) (i.e., P(m)=½(P(a)+P(b)) may be used as a prediction candidate for P(c). By assuming a distance-preserving mapping, a more accurate prediction candidate for A(c) can be selected based on proximity to the 2D texture coordinates to corresponding A(a), A(b), and A(m).

In some other example implementations, three 3D vertex neighbors may be used to predict a position of the next 3D vertex with the help of the positions of the corresponding 2D texture coordinates. For such predictions, consider a triangle defined by vertices a, b, and c, and a to-be predicted vertex d. It is assumed that the encoder and decoder are aware of (e.g., have reconstructed in the decoder, or in the decoding loop of an encoder):
The 3D positions P(a), P(b), and P(c) of vertices a, b, and c, respectively; and
The 2D texture coordinates A(a), A(b), A(c), and A(d) for all vertices a, b, c, and d.

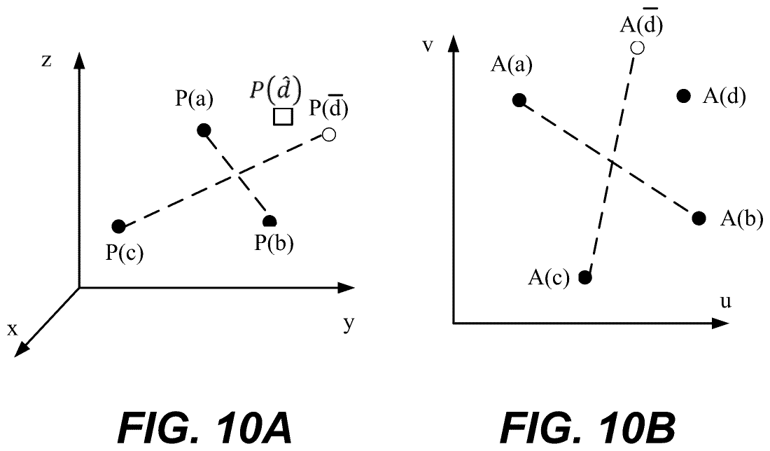

The goal is to predict the 3D position P(d) for vertex d using the known/reconstructed 3D positions P(a), P(b) and P(c) (in either the encoder or the decoder) and additionally using the reconstructed 2D texture coordinates A(a), A(b), A(c), and A(d) (in either the encoder or the decoder) in a shape preserving manner. The reconstructed P(a), P(b), P(c), A(a), A(b), A(c), and A(d) would be the actual 3D and 2D positions if the compression is lossless. Example implementations are illustrated in FIGS. 10A, 11A, and 12A and FIGS. 10B, 11B, and 12B, showing these 3D positions and 2D texture coordinates, respectively. These examples are implemented to achieve three-neighbor prediction based on shape preserving adaptive scaling.

In a first example implementation for deriving a shape-preserving prediction of P(d) using known P(a), P(b), P(c), A(a), A(b), A(c), and A(d), a set of prediction weighting factors (alternatively referred to as prediction weights) may be derived based the know 2D positions A(a), A(b), A(c), and A(d) and applied to the know 3D positions P(a), P(b), P(c) to generate the predictor for 3D position P(d). The weight factor derivation may, for example, be based on a parallelogram strategy in the 2D texture domain.

In such an implementation, the prediction weights may be derived in the 2D domain as optimization of:

$$arg {min}_{{w}_{1 , 2 , 3}} \vert A ( d ) - ( {w}_{1} A ( a ) + {w}_{2} A ( b ) + {w}_{3} A ( c ) ) \vert ,$$

where w_{1,2,3} represents the prediction weights that, when applied to the known 2D positions A(a), A(b), A(c), optically predict the known 2D position A(d) (with minimum prediction error). Such a linear application of the prediction weights represents a parallelogram strategy in the 2D domain. Then, the optimal parallelogram prediction weights w_{1,2,3} may be applied to the known 3D positions P(a), P(b), P(c) to generate a predictor for the 3D position P(d):

$$Predictor for P ( d ) = {w}_{1}^{*} P ( a ) + {w}_{2}^{*} P ( b ) + {w}_{3}^{*} P ( c )$$

Such an implementation, while exploiting correlation between 2D positions and 3D positions for improving coding efficiency of 3D positions, the predictor nevertheless would be in the plane of P(b), P(c), A(a) due to the linear weighted sum and thus may still not be able to count for prediction inaccuracy due to the P(d) being out of the P(b), P(c), A(a) plane.

In a second example implementation for deriving a shape-preserving prediction of P(d) using known P(a), P(b), P(c), A(a), A(b), A(c), and A(d), an initial predicator for P(d) may be identified first within the 3D domain using, for example, the parallelogram prediction strategy, based on the known P(a), P(b), and P(c), and this initial predictor for P(d) may then be further corrected using information from the 2D domain. Such a correction may be derived as a three-dimensional scaling factor. This example implementation may be referred to as correction scaling based prediction for cross data-set prediction (using 2D information to predict 3D position). This example implementation is illustrated in FIG. 10A and FIG. 10B, showing the 3D domain and the 2D domain, respectively. The known 3D positions P(a), P(b), P(c), and 2D coordinates A(a), A(b), A(c), and A(d) in FIG. 10A and FIG. 10B are labeled as such and shown as solid circles.

Specifically, a parallelogram prediction may be performed in the 3D domain using P(a), P(b), and P(c) to generate P(d) representing the initial predictor for P(d). The initial predictor P(d̅) is so labeled in FIG. 10A and shown an open circle. Likewise, a parallelogram prediction may also be performed in the 2D domain using A(a), A(b), and A(c) to generate a parallelogram prediction A(d) for the 2D position A(d). The predictor A(d̅) is so labeled in FIG. 10B and shown an open circle. Then, an adaptive scaling factor may be derived in the 2D texture coordinate to correct the initial 3D domain parallelogram prediction A(d̅). The adaptive scaling factor, for each dimension i in 3D, may be derived as:

$${S}_{i} = \frac{{A ( \overline{d} )}_{i}}{{A ( d )}_{i}} , i = 0 , 1 , 2$$

where the subscript “i” is added for projecting the 2D position into the three dimensions or the three axes of the 3D domain. This scaling factor of each dimension in 3D is then applied to correct the initial parallelogram prediction in 3D position in each of the three dimensions as:

P(â)=sᵢP(d̅)ᵢ

In some example implementations, the prediction P(d) may further be clipped within the given range of the initial prediction P(d) to prevent significant change.

$$P ( \hat{d} ) = CLIP ( {s}_{i} {P ( \overline{d} )}_{i} , [ {p ( \overline{d} )}_{i} - {Δ}_{i}^{0} , {P ( \overline{d} )}_{i} + {Δ}_{i}^{1} ] )$$

where Δᵢ^{0,1} is the clipping range.

The correction scaling based cross-dataset approach above can generate predictor P(\hat{d}) for P(d) that is out-of-plane of P(a), P(b), and P(c), as each of the 3D dimensions is scaled separately. This may facilitate generating more accurate predictors for cross vertices (or non-planar vertices).

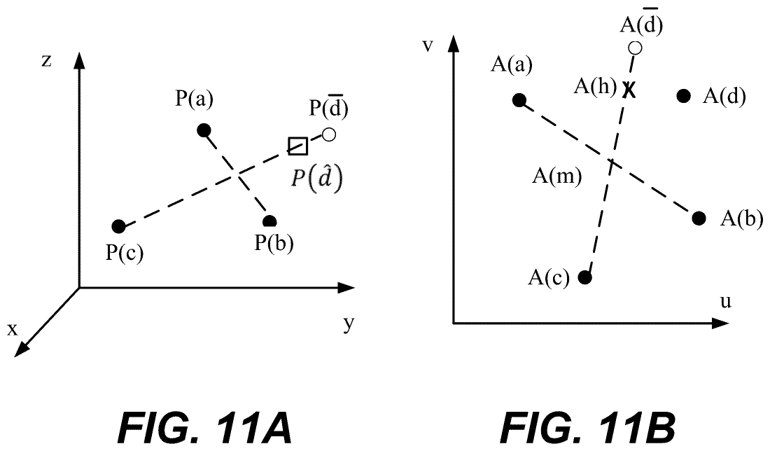

In a third example implementation for deriving a shape-preserving prediction of P(d) using known P(a), P(b), P(c), A(a), A(b), A(c), and A(d), an adjustment scaling is performed on a direction of parallelogram prediction in the 3D domain according to information derived from the 2D domain. Specifically and similar to the second example implementation above, an initial predicator P(d̅) for P(d) may be identified first within the 3D domain using, for example, the parallelogram prediction strategy, based on the known P(a), P(b), and P(c). This initial predictor P(d̅) may then be further adjusted using information from the 2D domain. Such an adjustment may be derived as a single scaling factor. This example implementation may be referred to as scaled or adjusted parallelogram prediction for cross data-set prediction (using 2D information to predict 3D position). This example implementation is illustrated in FIG. 11A and FIG. 11B, showing the 3D domain and the 2D domain, respectively. The known 3D positions P(a), P(b), P(c), and 2D coordinates A(a), A(b), A(c), and A(d) in FIG. 11A and FIG. 11B are labeled as such and shown as solid circles.

The single adjustment scaling is performed on the direction of parallelogram prediction. For example, the nearest point A(h) to A(d) on the parallelogram prediction direction A(c)-A(m) in the 2D domain is found, as shown in FIG. 11B. A(m) is the mid-point of A(a) and A(b). A(c) to A(m) represents the parallelogram prediction direction. A(h) is represented by the “x”. Then the adjustment scaling factor is identified as a distance ratio in the 2D domain by calculating:

$$S = \frac{{\vert A ( \hat{d} ) - A ( c ) \vert}_{2}^{2}}{{\vert A ( h ) - A ( c ) \vert}_{2}^{2}} ,$$

Then the 3D position prediction P(\hat{d}) for P(d) in the 3D domain may be obtained by as still being along the P(c)-P(m) direction and with a ratio between the distance between the parallelogram prediction P(d̅) and P(c) and the distance between the final predictor P(\hat{d}) and P(c) being the scaling fact s, as shown in FIG. 11A, where the final predictor P(\hat{d}) is shown as the open square.

The approach above need not to use A(d) and the prediction in the 3D domain is in-plane, since the final predictor is along the parallelogram direction.

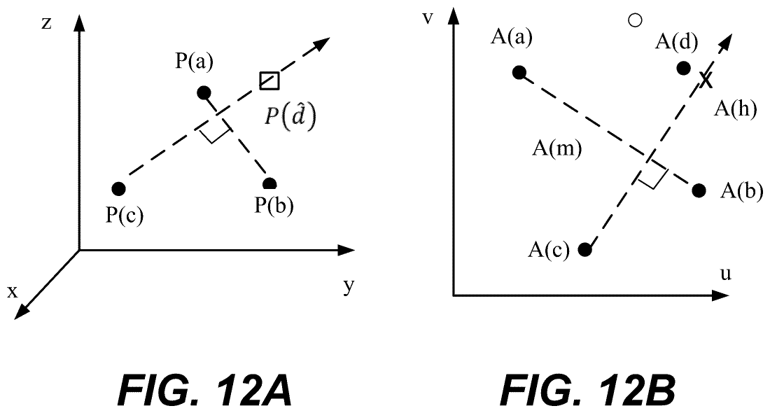

In a fourth example implementation for deriving a shape-preserving prediction of P(d) using known P(a), P(b), P(c), A(a), A(b), A(c), and A(d), an angle preserving 3D position prediction may be employed in the 3D domain based on the corresponding 2D texture coordinates. An example is shown in FIG. 12A and FIG. 12B.

For example, an angle preserving predictor may be identified in the 2D domain, as shown in FIG. 12B as A(h), which is the nearest point to A(d) on the angle preserving line (arrowed dashed line). A scaling factor may be derived based on A(h) with respect to other points in the 2D domain. The derived scaling factor may be allowed in the 3D domain to determine the predictor P(\hat{d}) (illustrated as open square) for P(d) on the angle preserving line (the arrowed dashed line) in FIG. 12A.

The various example implementations above for cross-domain (the 3D domain and 2D domain) shape preserving predictive encoding takes full advantage of the conformal mapping's ability to preserve local shapes, which may be crucial for complex mesh structures. The adaptive scaling ensures that the prediction respects the actual 3D geometry of the mesh, thus achieving a more efficient and accurate encoding.

An example encoding process for encoding 2D position ahead of time and using the 2D information to encode the 3D position is further described. The encoder may first receive at least a portion of the 3D mesh (e.g., a mesh component, a mesh object, etc.), but referred to herein as the 3D mesh. The 3D mesh may include 3D dataset for 3D positions of the 3D geometry vertices of the 3D mesh. A 2D texture mapping may be generated which contains a set of 2D texture coordinates of the vertices of the 3D mesh. The 3D geometry vertices may be mapped to the 2D texture coordinates (one-to-one or one-to-many, as described above). For compressing the 3D positions and 2D coordinates, the encoder may compress the 2D coordinates first using any suitable compression algorithm. The encoder may then encode or compress the 3D position using a prediction algorithm that depends on the 3D information as well as the 2D information. The encoder, for example, may progressively scan the 3D vertices to encode the 3D positions, and for encoding a next vertex, the encoder may reconstructed one or more already encoded neighboring vertices of the next vertex to be encoded, reconstruct one or more already encoded 2D texture coordinates, and use the reconstructed 3D positions of these neighboring vertices in conjunction with one or more reconstructed 2D coordinates to generated a predictor of the position of the next vertex in the 3D domain using any of the prediction mechanisms described above, e.g., the example shape-preserving cross-domain prediction methods, or any other mechanism. The encoder may then encode the 3D position of the next vertex as a residue between the known input position of that vertex and the predictor.

An example decoding process for decoding 2D position ahead of time and using the 2D information to decode the 3D position from a compressed or encoded 3D mesh bitstream is further described. The decoder may first receive encoded bitstream of at least a portion of the 3D mesh (e.g., a mesh component, a mesh object, etc.), but referred to herein as the 3D mesh. The encoded 3D mesh may include encoded 3D dataset for 3D positions of 3D geometry vertices of the 3D mesh and 2D dataset for 2D coordinates mapped to the 3D geometry vertices. The decoder may first decode the encoded 2D positions to generate reconstructed 2D coordinates. The decoder may also progressively decode the encoded 3D positions based the information from the encoded 3D position and reconstructed 2D coordinates. For extracting a next 3D vertex position, the decoder may first decode the bitstream to obtain residual of the next 3D vertex position, use already reconstructed 3D positions of one or more neighboring vertices and additionally already reconstructed values of one or more 2D coordinates to restore the predictor for the position of the next 3D vertex using any of the prediction mechanisms described above, e.g., the example shape-preserving cross-domain prediction methods, or any other mechanism. The position of the next 3D vertex is then derived from the reconstructed residual and the predictor.

Finally, the various implementations above may be applied to any portion of a 3D mesh. The cross-domain encoding/decoding dependency between 2D and 3D may be adaptively employed during the encoding or decoding process based on the data set. From encoder standpoint such dependency may be determined and then signaled in the bitstream at any level of the 3D mesh. Alternatively, the adaptive dependency may be derived from other information derived from the 3D mesh data such that both the encoder and the decoder can make that derivation without explicit signaling in the bitstream. In such a manner, some portion of the 3D mesh may be coded such that the encoding/decoding of the 3D positions are dependent on the 2D information, whereas for some other portions of the 3D mesh, the encoding/decoding of the 2D positions are dependent on the 3D information. Such adaptivity of encoding order and dependency may applied to other 3D mesh datasets of attributes for achieving adaptive cross-dataset (cross-attribute) encoding/decoding.

The adaptivity above for 2D and 3D position encoding/decoding may be made either at the level of the entire mesh or within sub-meshes, based on a pre-calculated metric of distance preservation between the 3D positions and their corresponding 2D texture mappings.

As an example for adaptive 2D and 3D position encoding/decoding, a primary criterion for adaptation may be based on the extent to which the 3D to 2D mapping preserves distances. If the mapping maintains distances effectively for the majority of the portion of the mesh, then the 2D texture coordinates may be encoded first and the encoding/decoding of 3D positions may depend on the 2D information. Conversely, if the 3D geometry positions are found to be better preserved, they may be encoded first and the encoding/decoding of 2D textural coordinates may depend on the 3D information.

In some further example implementations, adaptive position prediction may be employed, in which an adaptive selection between different position prediction techniques may be used. For example, if the pre-calculation suggests that stretching prediction (which assumes some form of distance preservation) is more accurate, it is preferred. Otherwise, alternative methods such as parallelogram prediction are used. Such consideration may be applied within 2D domain, within 3D domain, or cross the 2D and 3D domains.

The adaptive strategy above help optimize coding efficiency by exploiting the inherent geometric properties of the mesh. By dynamically selecting the most suitable encoding order and prediction method, the algorithm can more effectively compress the mesh data, reducing redundancy and enhancing the final compression ratio.

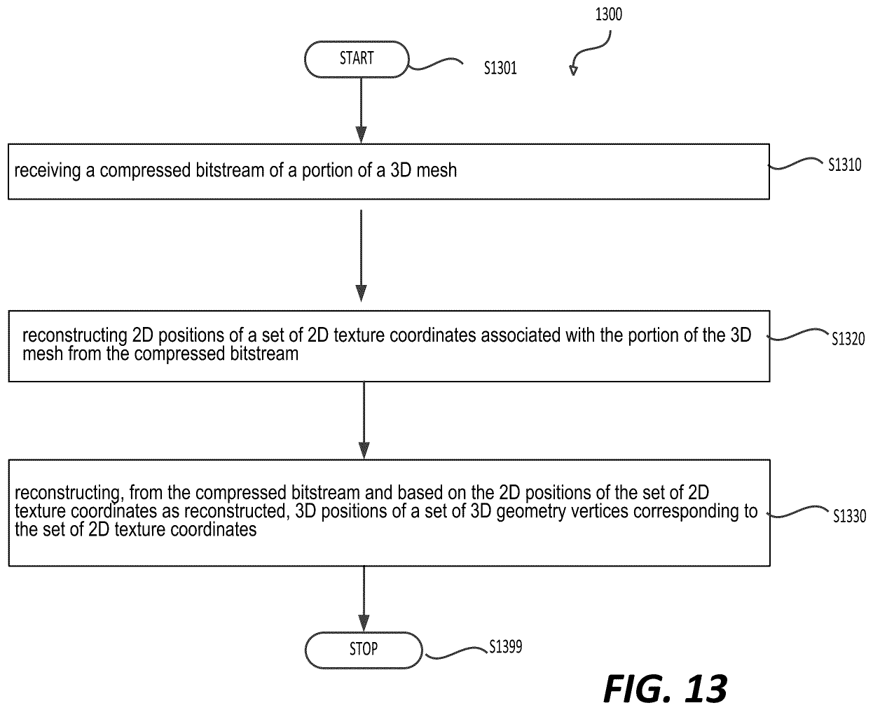

FIG. 13 shows a flow chart for an example process (1300) according to an embodiment of the disclosure. The process (1300) starts at step (S1301). In Step (S1310), a compressed bitstream of a portion of the 3D mesh is received. In Step (S1320), 2D positions of a set of 2D texture coordinates associated with the portion of the 3D mesh are reconstructed from the compressed bitstream. In Step (S1330), 3D positions of a set of 3D geometry vertices corresponding to the set of 2D texture coordinates are reconstructed from the compressed bitstream and based on the 2D positions of the set of 2D texture coordinates as reconstructed. The procedure (1300) stops at (S1399).

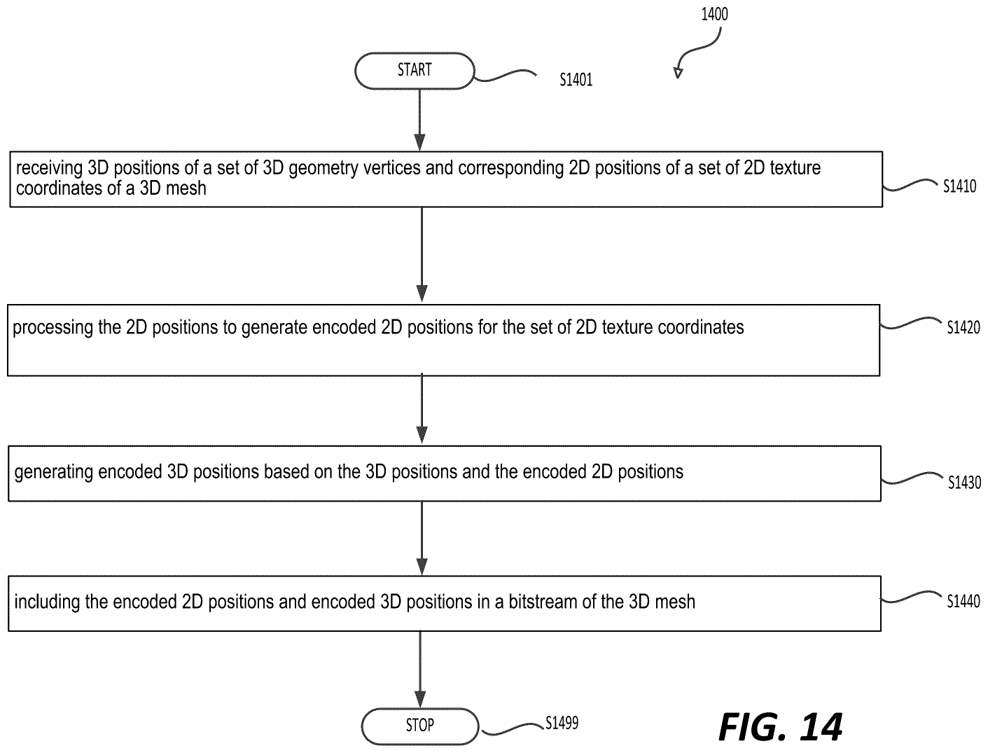

FIG. 14 shows a flow chart for an example process (1400) according to an embodiment of the disclosure. The process (1400) starts at step (S1401). In Step (S1410), 3D positions of a set of 3D geometry vertices and corresponding 2D positions of a set of 2D texture coordinates of the 3D mesh are received. In Step (S1420), the 2D positions to are processed to generate encoded 2D positions for the set of 2D texture coordinates. In Step (S1430), encoded 3D positions are generated based on the 3D positions and the encoded 2D positions. In Step (S1440), the encoded 2D positions and encoded 3D positions are included in a bitstream of the 3D mesh. The procedure (1400) stops at (S1499).

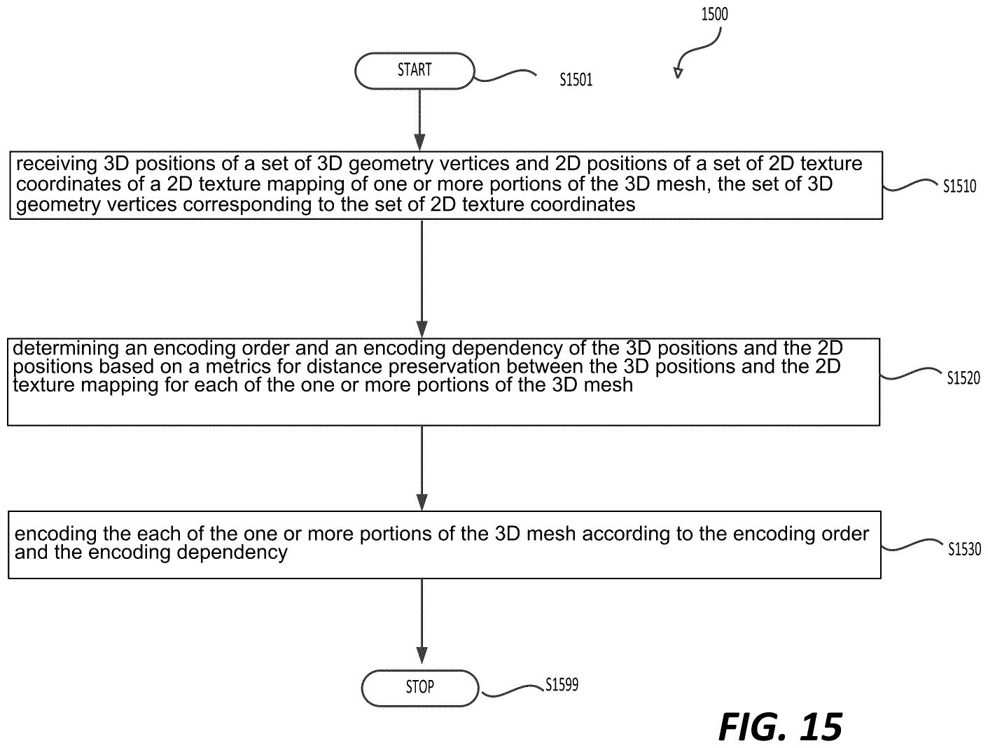

FIG. 15 shows a flow chart for an example process (1500) according to an embodiment of the disclosure. The process (1500) starts at step (S1501). In Step (S1510), 3D positions of a set of 3D geometry vertices and 2D positions of a set of 2D texture coordinates of a 2D texture mapping of one or more portions of the 3D mesh are received, the set of 3D geometry vertices corresponding to the set of 2D texture coordinates. In Step (S1520), an encoding order and an encoding dependency of the 3D positions and the 2D positions are determined based on a metrics for distance preservation between the 3D positions and the 2D texture mapping for each of the one or more portions of the 3D mesh. In Step (S1530), the each of the one or more portions of the 3D mesh is encoded according to the encoding order and the encoding dependency. The procedure (1500) stops at (S1599).

The processes (1300), (1400), and (1500) can be suitably adapted. Step(s) in the processes (1300), (1400), and (1500) can be modified and/or omitted. Additional step(s) can be added. Any suitable order of implementation can be used.

The techniques disclosed in the present disclosure may be used separately or combined in any order. Further, each of the techniques (e.g., methods, embodiments), encoder, and decoder may be implemented by processing circuitry (e.g., one or more processors or one or more integrated circuits). In some examples, the one or more processors execute a program that is stored in a non-transitory computer-readable medium.

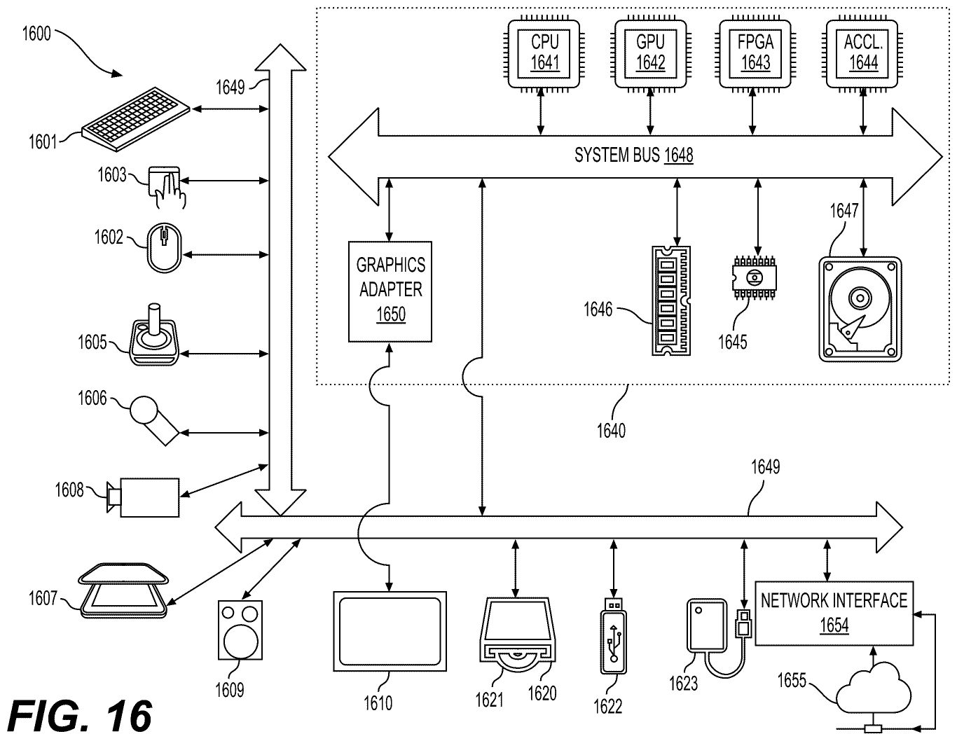

The techniques described above, can be implemented as computer software using computer-readable instructions and physically stored in one or more computer-readable media. For example, FIG. 16 shows a computer system (1600) suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 16 for computer system (1600) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (1600).

Computer system (1600) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1601), mouse (1602), trackpad (1603), touch screen (1610), data-glove (not shown), joystick (1605), microphone (1606), scanner (1607), camera (1608).

Computer system (1600) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1610), data-glove (not shown), or joystick (1605), but there can also be tactile feedback devices that do not serve as input devices), audio output devices (such as: speakers (1609), headphones (not depicted)), visual output devices (such as screens (1610) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1600) can also include human accessible storage devices and their associated media such as optical media including CD/DVD ROM/RW (1620) with CD/DVD or the like media (1621), thumb-drive (1622), removable hard drive or solid state drive (1623), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1600) can also include an interface (1654) to one or more communication networks (1655). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general-purpose data ports or peripheral buses (1649) (such as, for example USB ports of the computer system (1600)); others are commonly integrated into the core of the computer system (1600) by attachment to a system bus as described below (for example Ethernet interface into a PC computer system or cellular network interface into a smartphone computer system). Using any of these networks, computer system (1600) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1640) of the computer system (1600).

The core (1640) can include one or more Central Processing Units (CPU) (1641), Graphics Processing Units (GPU) (1642), specialized programmable processing units in the form of Field Programmable Gate Areas (FPGA) (1643), hardware accelerators for certain tasks (1644), graphics adapters (1650), and so forth. These devices, along with Read-only memory (ROM) (1645), Random-access memory (1646), internal mass storage such as internal non-user accessible hard drives, SSDs, and the like (1647), may be connected through a system bus (1648). In some computer systems, the system bus (1648) can be accessible in the form of one or more physical plugs to enable extensions by additional CPUs, GPU, and the like. The peripheral devices can be attached either directly to the core's system bus (1648), or through a peripheral bus (1649). In an example, the screen (1610) can be connected to the graphics adapter (1650). Architectures for a peripheral bus include PCI, USB, and the like.

CPUs (1641), GPUs (1642), FPGAs (1643), and accelerators (1644) can execute certain instructions that, in combination, can make up the aforementioned computer code. That computer code can be stored in ROM (1645) or RAM (1646). Transitional data can be also be stored in RAM (1646), whereas permanent data can be stored for example, in the internal mass storage (1647). Fast storage and retrieve to any of the memory devices can be enabled through the use of cache memory, that can be closely associated with one or more CPU (1641), GPU (1642), mass storage (1647), ROM (1645), RAM (1646), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1600), and specifically the core (1640) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1640) that are of non-transitory nature, such as core-internal mass storage (1647) or ROM (1645). The software implementing various embodiments of the present disclosure can be stored in such devices and executed by core (1640). A computer-readable medium can include one or more memory devices or chips, according to particular needs. The software can cause the core (1640) and specifically the processors therein (including CPU, GPU, FPGA, and the like) to execute particular processes or particular parts of particular processes described herein, including defining data structures stored in RAM (1646) and modifying such data structures according to the processes defined by the software. In addition, or as an alternative, the computer system can provide functionality as a result of logic hardwired or otherwise embodied in a circuit (for example: accelerator (1644)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method for decoding a 3D mesh, comprising:
receiving a compressed bitstream of a portion of the 3D mesh;
reconstructing 2D positions of a set of 2D texture coordinates associated with the portion of the 3D mesh from the compressed bitstream; and
reconstructing, from the compressed bitstream and based on the 2D positions of the set of 2D texture coordinates as reconstructed, 3D positions of a set of 3D geometry vertices corresponding to the set of 2D texture coordinates.

2. The method of claim 1, further comprising: reconstructing, from the compressed bitstream, connectivity of the set of 3D geometry vertices and connectivity of the set of 2D texture coordinates prior to reconstructing the 2D positions of the set of 2D texture coordinates.

3. The method of claim 1, further comprising reconstructing from the compressed bitstream the 2D positions of the set of 2D texture coordinates along with connectivity of the set of 2D texture coordinates in tandem.

4. The method of claim 1, wherein reconstructing from the compressed bitstream the 3D positions of the set of 3D geometry vertices based on the 2D positions of the set of 2D texture coordinates as reconstructed is based on a shape-preserving prediction.

5. The method of claim 1, wherein reconstructing from the compressed bitstream the 3D positions of the set of 3D geometry vertices based on the 2D positions of the set of 2D texture coordinates as reconstructed comprises:
obtaining reconstructed 3D positions of a first, a second, and a third 3D geometry vertices of the 3D mesh;
obtaining reconstructed 2D positions of a first, a second, a third, and a fourth 2D texture coordinates corresponding to the first, the second, the third, and a fourth 3D geometry vertices, respectively; and
deriving a 3D position of the fourth 3D geometry vertex based on the reconstructed 3D positions of the first, the second, and the third geometry vertices and the reconstructed 2D positions of the first, the second, the third, and the fourth 2D texture coordinates.

6. The method of claim 5, wherein deriving the 3D position of the fourth 3D geometry vertex based on the reconstructed 3D positions of the first, the second, and the third geometry vertices and the reconstructed 2D positions of the first, the second, the third, and the fourth 2D texture coordinates comprises:
determining weighting factors for generating a weighted sum of the reconstructed 2D positions of the first, the second, and the third 2D texture coordinates that optimally predicts the reconstructed 2D position of the fourth 2D texture coordinate;
applying the weighting factors to the reconstructed 3D positions of the first, the second, and the third 3D geometry vertices to generate a weighted 3D position sum; and
using the weighted 3D position sum as a predictor to obtain the 3D position of the fourth 3D geometry vertex.

7. The method of claim 5, deriving the 3D position of the fourth 3D geometry vertex based on the reconstructed 3D positions of the first, the second, and the third geometry vertices and the reconstructed 2D positions of the first, the second, the third, and the fourth 2D texture coordinates comprises:
deriving a 2D position predictor for the fourth 2D texture coordinate based on the reconstructed 2D positions of the first, the second, and the third 2D texture coordinates using a predefined geometric prediction mechanism;
deriving a scaling factor that indicates a prediction accuracy of the 2D position predictor on the reconstructed 2D position of the fourth 2D texture coordinate;
deriving an initial 3D position predictor for the fourth 3D geometry vertex based on the reconstructed 3D positions of the first, the second, and the third 3D geometry vertices using the predefined geometric prediction mechanism;
applying the scaling factor to the initial 3D position predictor to generate a modified 3D position predictor; and
using the modified 3D position predictor to obtain the 3D position of the fourth 3D geometry vertex.

8. The method of claim 7, wherein:
the predefined geometric prediction mechanism comprises a parallelogram prediction; and
the scaling factor is derived as a ratio between the 2D position predictor and the reconstructed 2D position of the fourth 2D texture coordinate.

9. The method of claim 7, wherein;
the predefined geometric prediction mechanism comprises a parallelogram prediction; and
the scaling factor is derived as a ratio between a first distance and a second distance, the first distance being between the 2D position predictor and a reconstructed position of an opposing 2D texture coordinate to the fourth 2D textual coordinate among the first, the second, and the third 2D texture coordinates, and the second distance being between the reconstructed 2D position of the fourth 2D textual coordinate and the reconstructed position of the opposing 2D texture coordinate.

10. The method of claim 7, wherein the predefined geometric prediction mechanism comprises an angle preserving prediction.

11. An electronic device for encoding a 3D mesh, comprising a memory for storing instructions and at least one processor in communication with the memory and for executing the instructions to:
receive 3D positions of a set of 3D geometry vertices and corresponding 2D positions of a set of 2D texture coordinates of the 3D mesh;
process the 2D positions to generate encoded 2D positions for the set of 2D texture coordinates;
generate encoded 3D positions based on the 3D positions and the encoded 2D positions; and
include the encoded 2D positions and encoded 3D positions in a bitstream of the 3D mesh.

12. The electronic device of claim 11, the at least one processor is configured to execute the instructions to: encode connectivity of the 3D geometry vertices and connectivity of the 2D texture coordinates prior to encoding the 2D positions of the set of 2D texture coordinates, wherein the encoded 2D position is further generated based on the encoded connectivity of the 3D geometry vertices or the encoded the connectivity of the 2D texture coordinates.

13. The electronic device of claim 11, the at least one processor is configured to execute the instructions to generate the encoded 2D positions of the 2D texture coordinates along with connectivity of the 2D texture coordinates in tandem.

14. The electronic device of claim 11, wherein generating the encoded 3D positions based on the 3D positions and the encoded 2D positions is based on a shape-preserving prediction.

15. The electronic device of claim 11, wherein the at least one processor is configured to generate the encoded 3D positions of the set of 3D geometry vertices by:
determining reconstructed 3D positions of a first, a second, and a third geometry vertices of the 3D mesh;
determining reconstructed 2D positions of a first, a second, a third, and a fourth 2D texture coordinates corresponding to the first, the second, the third, and a fourth 3D geometry vertices, respectively; and
encoding a 3D position of the fourth 3D geometry vertex based on the reconstructed 3D positions of the first, the second, and the third geometry vertices and the reconstructed 2D positions of the first, the second, the third, and the fourth 2D texture coordinates.

16. The electronic device of claim 15, wherein the at least one processor is configured to encode the 3D position of the fourth 3D geometry vertex by:
determining weighting factors for generating a weighted sum of the reconstructed 2D positions of the first, the second, and the third 2D texture coordinates that optimally predicts the reconstructed 2D position of the fourth 2D texture coordinate;
applying the weighting factors to the reconstructed 3D positions of the first, the second, and the third 3D geometry vertices to generate a weighted 3D position sum; and
using the weighted 3D position sum as a predictor to encode the 3D position of the fourth 3D geometry vertex.

17. The electronic device of claim 15, wherein the at least one processor is configured to encode the 3D position of the fourth 3D geometry vertex by:
deriving a 2D position predictor for the fourth 2D texture coordinate based on the reconstructed 2D positions of the first, the second, and the third 2D texture coordinates using a predefined geometric prediction mechanism;
deriving a scaling factor that indicates a prediction accuracy of the 2D position predictor on the reconstructed 2D position of the fourth 2D texture coordinate;
deriving an initial 3D position predictor for the fourth 3D geometry vertex based on the reconstructed 3D positions of the first, the second, and the third 3D geometry vertices using the predefined geometric prediction mechanism;
applying the scaling factor to the initial 3D position predictor to generate a modified 3D position predictor; and
using the modified 3D position predictor to encode the 3D position of the fourth 3D geometry vertex.

18. The electronic device of claim 17, wherein
the predefined geometric prediction mechanism comprises a parallelogram prediction; and
the scaling factor is derived as a ratio between the 2D position predictor and the reconstructed 2D position of the fourth 2D texture coordinate or as a ratio between a first distance and a second distance, the first distance being between the 2D position predictor and a reconstructed position of an opposing 2D texture coordinate to the fourth 2D textual coordinate among the first, the second, and the third 2D texture coordinates, and the second distance being between the reconstructed 2D position of the fourth 2D textual coordinate and the reconstructed position of the opposing 2D texture coordinate.

19. A method for encoding a 3D mesh, comprising:
receiving 3D positions of a set of 3D geometry vertices and 2D positions of a set of 2D texture coordinates of a 2D texture mapping of one or more portions of the 3D mesh, the set of 3D geometry vertices corresponding to the set of 2D texture coordinates;
determining an encoding order and an encoding dependency of the 3D positions and the 2D positions based on a metrics for distance preservation between the 3D positions and the 2D texture mapping for each of the one or more portions of the 3D mesh; and
encoding the each of the one or more portions of the 3D mesh according to the encoding order and the encoding dependency.

20. The method of claim 19, further comprising selecting a prediction mechanism when encoding the each of the portions of the 3D mesh according to optimizing a prediction accuracy measure or encoding efficiency.
